(19) United States
(12) Patent Application Publication
(10) Pub. No.: US 2015/0177711 A1
(43) Pub. Date: Jun. 25, 2015

(54) DEVICE CONTROL SYSTEM, CONTROL APPARATUS AND COMPUTER-READABLE MEDIUM

(71) Applicants: Hajime Yuzurihara, Kanagawa (JP); Takanori Inadome, Kanagawa (JP); Takeo Tsukamoto, Kanagawa (JP); Hideaki Aratani, Kanagawa (JP)

(72) Inventors: Hajime Yuzurihara, Kanagawa (JP); Takanori Inadome, Kanagawa (JP); Takeo Tsukamoto, Kanagawa (JP); Hideaki Aratani, Kanagawa (JP)

(21) Appl. No.: 14/415,934

(22) PCT Filed: Jul. 19, 2013
(86) PCT No.: PCT/JP2013/070266

§ 371 Date: Jan. 20, 2015

(30) Foreign Application Priority Data
Jul. 23, 2012 (JP) 2012-163062
Apr. 22, 2013 (JP) 2013-089495

(51) Int. Cl. G05B 13/02

(52) U.S. Cl. CPC G05B 13/026

(57) ABSTRACT

An electric device control system includes: a position locating apparatus detecting positions and motion states of people; and a control apparatus controlling electric device, the position locating apparatus comprising: a first receiving unit receiving data from the people; a position determining unit obtaining information of the people; a motion-state detecting unit obtaining motion state information of the people; and a transmitting unit transmitting the position information and the motion state information of the people to the control apparatus, and the control apparatus comprising: a second receiving unit receiving the position information and the motion state information, a determining unit assigning priority to the people based on the position information and the motion state information, and a device control unit controlling a device associated with the people in accordance with the priority such that the device associated with the people becomes a predetermined status of the people.

### TECHNICAL FIELD

The present invention relates to a device control system, a control apparatus, a device control method, and a computer readable medium.

### BACKGROUND ART

A variety of systems that controls various types of electrical devices placed at home, office, or the like are proposed in recent years to reduce power consumption and increase comfort. For instance, a known technique for a home network system controls home electrical devices as follows. ID codes assigned with priority levels are received from transmitters carried by respective people. Electrical devices, such as a personal computer, an air conditioner, a lighting device, a television, and an audio device, are controlled depending on a location of people of a high priority level (see Japanese patent laid-open publication No. 2000-275318).

According to another known technique for a system that controls devices in a dwelling house, a user position inside and outside the dwelling house is determined by near field communication, GPS, or the like. Information about behavior history of the user is acquired based on relationship between the determined user position and operation history of a lighting device and an air conditioner near the user position. User's behavior that will be made after a predetermined period of time is predicted from the behavior history of the user. The lighting device and the air conditioner corresponding to the predicted user's behavior are controlled (see Japanese patent No. 4809805).

According to still another known technique for a system that controls a lighting device, an air conditioner, and OA equipment in an office, power-consumption-reduction priority levels are assigned to the devices in the office in advance. When total power consumption of the devices becomes equal to or higher than a reference value, power consumption of the devices is reduced one device by one device in order of decreasing priority level (see Japanese patent No. 4145198).

However, it is difficult to apply the technique described in Japanese patent No. 4809805 to a situation where priority levels cannot be assigned in advance; this is because this technique includes assigning priority levels to respective people in advance and controlling the devices so as to increase comfort and convenience of people of a high priority level. For instance, in a situation where a plurality of people are performing activities in an office, it is desired to put higher priority on convenience and comfort of people performing tasks than those of people at rest. However, because human behavior varies at any time, priority levels cannot be assigned to these people in advance.

The technique described in Japanese patent No. 4809805 controls devices by predicting future behavior of people from his/her behavior history, and therefore is effective in a situation where the person repeats similar behavior patterns. However, in a situation where the person behaves differently from his/her past behavior pattern, the technique fails to control the devices appropriately.

The technique described in Japanese patent No. 4145198 reduces power consumption of the devices one device by one device in order of decreasing priority level when the total power consumption of the devices becomes equal to or higher than the reference value. Accordingly, this technique can be highly effective in power conservation when, for instance, high priority level is assigned to an air conditioner that consumes large power. However, this technique can impair comfort of people performing tasks in the office and lead to a decrease in productivity in the tasks.

It is desired that people performing tasks in an office manually switch on and off devices with consciousness of eliminating useless consumption at all times to achieve power conservation in the office. However, there is a limit to thoroughness with which every people acts with such consciousness at all times. Therefore, there is a need for a system capable of power conservation by automatic control while maintaining comfort of people performing tasks to thereby reduce a decrease in productivity in the tasks.

In light of the foregoing, it is a primary object of the present invention to provide a device control system, a control apparatus, and a device control method including computer readable medium that can achieve further power conservation while maintaining comfort of people performing tasks to thereby reduce a decrease in productivity in the tasks.

### DISCLOSURE OF INVENTION

According to an aspect of the invention, an electric device control system is provided. The electric device control system includes: a position locating apparatus that detects positions and motion states of people in a control target area; and a control apparatus that controls at least one electric device in the control target area, the control apparatus being connected to the position locating apparatus through a network, the position locating apparatus including: a first receiving unit that receives detection data from the people; a position determining unit that determines and obtains position information of the people in the control target area based on the detection data; a motion-state detecting unit that detects and obtains motion state information of the people based on the detection data; and a transmitting unit that transmits the obtained position information and the obtained motion state information of the people to the control apparatus, and the control apparatus including: a second receiving unit that receives the position information and the motion state information of the people from the position locating apparatus, a determining unit that assigns a predetermined priority to the people based on at least one of the position information and the motion state information of the people, and a device control unit that controls a device associated with the people in accordance with the priority such that the device associated with the people becomes a predetermined status based on at least one of the position information and the motion state information of the people.

According to another aspect of the invention, a controller connected to a position locating apparatus is provided. The controller connected to a position locating apparatus that detects positions and motion states of people in a control target area and configured to control at least one electric device in the control target area, the position locating apparatus includes: a first receiving unit that receives detection data from the people; a position determining unit that determines and obtains position information of the people in the control target area based on the detection data; a motion-state detecting unit that detects and obtains motion state information of the people based on the detection data; and a transmitting unit that transmits the obtained position information and the obtained motion state information of the people to the control apparatus, and the control apparatus includes: a second receiving unit that receives the position information and the motion state information of the people from the position locating apparatus, a determining unit that assigns a predetermined priority to the people based on at least one of the position information and the motion state information of the people, and a device control unit that controls a device associated with the people in accordance with the priority such that the device associated with the people becomes a predetermined status based on at least one of the position information and the motion state information of the people.

According to another aspect of the invention, a computer readable medium storing instructions configured to perform the method executable by a controller is provided. The computer readable medium storing instructions configured to perform the method executable by a controller connected to a position locating apparatus that detects positions and motion states of people in a control target area and configured to control at least one electric device in the control target area, the position locating apparatus including: a first receiving unit that receives detection data from the people; a position determining unit that determines and obtains position information of the people in the control target area based on the detection data; a motion-state detecting unit that detects and obtains motion state information of the people based on the detection data; and a transmitting unit that transmits the obtained position information and the obtained motion state information of the people to the control apparatus, and the method including: receiving the position information and the motion state information of the people from the position locating apparatus; assigning a predetermined priority to the people based on at least one of the position information and the motion state information of the people; and controlling a device associated with the people in accordance with the priority such that the device associated with the people becomes a predetermined status based on at least one of the position information and the motion state information of the people.

According to an embodiment of the present invention, further power conservation can be achieved while maintaining comfort of people performing tasks to reduce a decrease in productivity in the tasks.

### BRIEF DESCRIPTION OF DRAWINGS

FIG. 1 is a network configuration diagram of a device control system according to an embodiment.

FIG. 2 is a diagram illustrating how a smartphone is worn.

FIG. 3 is a diagram illustrating an example, in which a worker wears an information device capable of detecting a motion of the worker separately from the smartphone.

FIG. 4A is diagram illustrating directions detected by sensors.

FIG. 4B is diagram illustrating direction detected by an angular velocity sensor.

FIG. 5 is a diagram illustrating an example of placement of monitoring cameras in a general office area.

FIG. 6 is a diagram illustrating an example of placement of LED lighting devices, electrical outlets, and air conditioners in the general office area.

FIG. 7 is a block diagram illustrating a functional configuration of a location server.

FIG. 8 is a waveform diagram of a vertical acceleration component produced when each of a sitting motion and a standing motion is performed.

FIG. 9 is a waveform diagram of a horizontal angular velocity component produced when each of a squatting motion and a standing motion is performed.

FIG. 10 is a waveform diagram of a vertical angular velocity component produced by a motion of changing an orientation in a resting state.

FIG. 11 is a waveform diagram of a horizontal angular velocity component of a head of a person that turns the person's eyes up away from a display in a sitting state.

FIG. 12 is a waveform diagram of a horizontal angular velocity component of the head of a person that turns the person's eyes down away from a display in a sitting state.

FIG. 13 is a block diagram illustrating a functional configuration of a control server according to the embodiment.

FIG. 14 is a flowchart illustrating a procedure for a detection process to be performed by the location server according to the embodiment.

FIG. 15 is a flowchart illustrating a procedure for a device control process according to the embodiment.

FIG. 16 is a diagram illustrating an example of a layout of an entire office and placement of LED lighting devices, electrical outlets, and air conditioners in each area.

FIG. 17 is a diagram illustrating an example of a control table for use in power conservation control.

FIG. 18 is a flowchart illustrating a procedure for the power conservation control.

FIG. 19 is a diagram illustrating a result of survey on relationship between power consumption level of an LED lighting device and decrease in worker's subjective task productivity.

### BEST MODE(S) FOR CARRYING OUT THE INVENTION

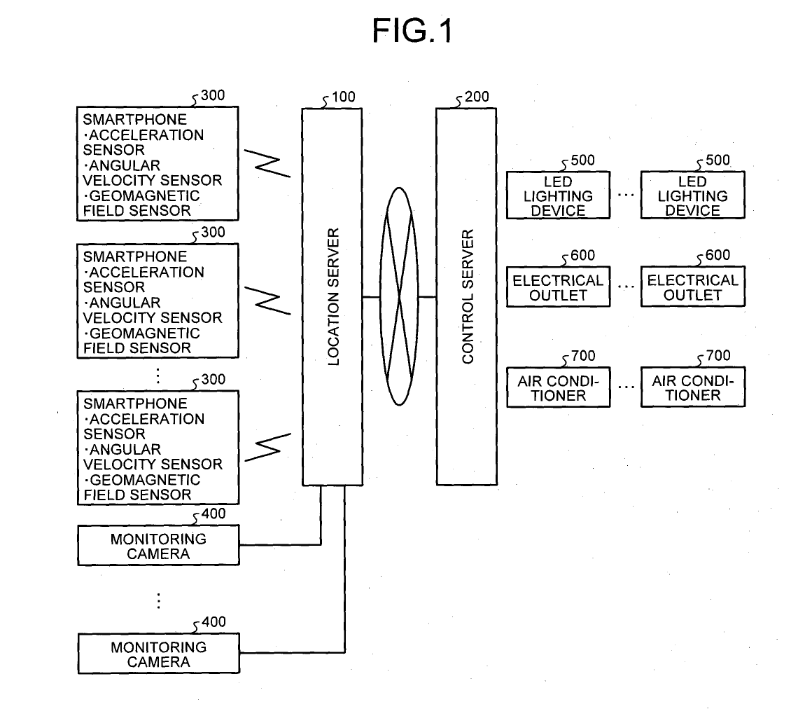

Exemplary embodiments are described in detail below with reference to the accompanying drawings. An embodiment described below is an example of application to a device control system for controlling devices in an office. FIG. 1 is a network configuration diagram of the device control system of the embodiment. As illustrated in FIG. 1, the device control system of the embodiment includes a plurality of smartphones 300, a plurality of monitoring cameras 400 as image capturing apparatuses, a location server 100, a control server 200, and controlled devices. The controlled devices are a plurality of light-emitting diode (LED) lighting devices 500, a plurality of electrical outlets 600, and a plurality of air conditioners 700.

The plurality of smartphones 300 and the plurality of monitoring cameras 400 are connected to the location server 100 over a wireless communication network of, for example, Wireless Fidelity (Wi-Fi). Note that a method for wireless communications is not limited to Wi-Fi. The monitoring cameras 400 and the location server 100 may alternatively be wire-connected.

The location server 100 and the control server 200 are connected to a network, such as the Internet or a local area network (LAN).

The plurality of LED lighting devices 500, the plurality of electrical outlets 600, and the plurality of air conditioners 700 are connected to the control server 200 over a wireless communication network of, for example, Wi-Fi.

The method for communication between the control server 200, and the plurality of LED lighting devices 500, the plurality of electrical outlets 600, and the plurality of air conditioners 700 is not limited to Wi-Fi; another wireless communication method may be utilized. Further alternatively, a wired communication method using an Ethernet (registered trademark) cable, power line communications (PLC), or the like can be used.

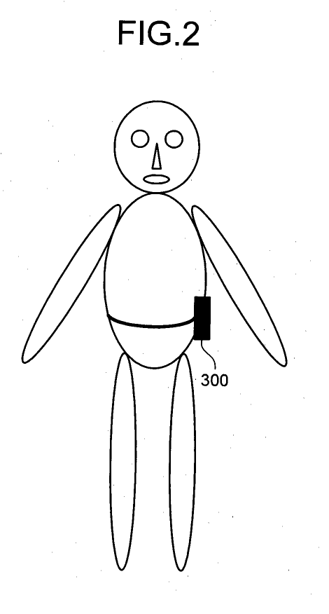

The smartphone 300 is an information device carried by a person (hereinafter, “worker”) performing a task in an office to transmit data signal detected from the worker. That is, in this embodiment, smartphone 300 is a information device for detecting and transmitting motion information of the worker. FIG. 2 is a diagram illustrating how the smartphone 300 is worn. The smartphone 300 may be carried by a hand or the like of the worker, or, alternatively, worn at waist of the worker as illustrated in FIG. 2.

Referring back to FIG. 1, each of the smartphones 300 includes an acceleration sensor, an angular velocity sensor, and a geomagnetic field sensor and transmits detection data output from each of the sensors to the location server 100 at fixed time intervals, e.g., every second. The detection data from the acceleration sensor is an acceleration vector. The detection data from the angular velocity sensor is an angular velocity vector. The detection data from the geomagnetic field sensor is a magnetic vector.

In the embodiment, the smartphones 300 are used as information devices that detect motions of workers. However, the information device is not limited to such a portable terminal as the smartphone 300, and can be any information device that includes an acceleration sensor, an angular velocity sensor, and a geomagnetic field sensor and is capable of detecting a motion of people.

There can be employed another configuration, in which the smartphone 300 includes an information device, such as an acceleration sensor, an angular velocity sensor, and a geomagnetic field sensor, for detecting a motion of people, and, furthermore, the worker wears another information device for detecting a motion of the person separately from the smartphone 300.

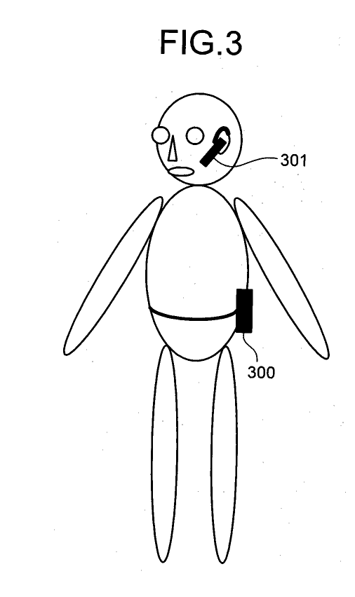

FIG. 3 is a diagram illustrating an example, in which a worker wears an information device capable of detecting a motion of the worker separately from the smartphone 300. As illustrated in FIG. 3, the worker can wear a small headset-type sensor group 301 that includes an acceleration sensor, an angular velocity sensor, and a geomagnetic field sensor at the worker's head separately from the smartphone 300. In this case, detection data obtained by the sensor group 301 can be either directly transmitted from the sensor group 301 to the location server 100 or transmitted to the location server 100 via the smartphone 300. When the sensor group 301 is worn at the head of the worker separately from the sensors of the smartphone 300 in this way, a variety of postures can be detected.

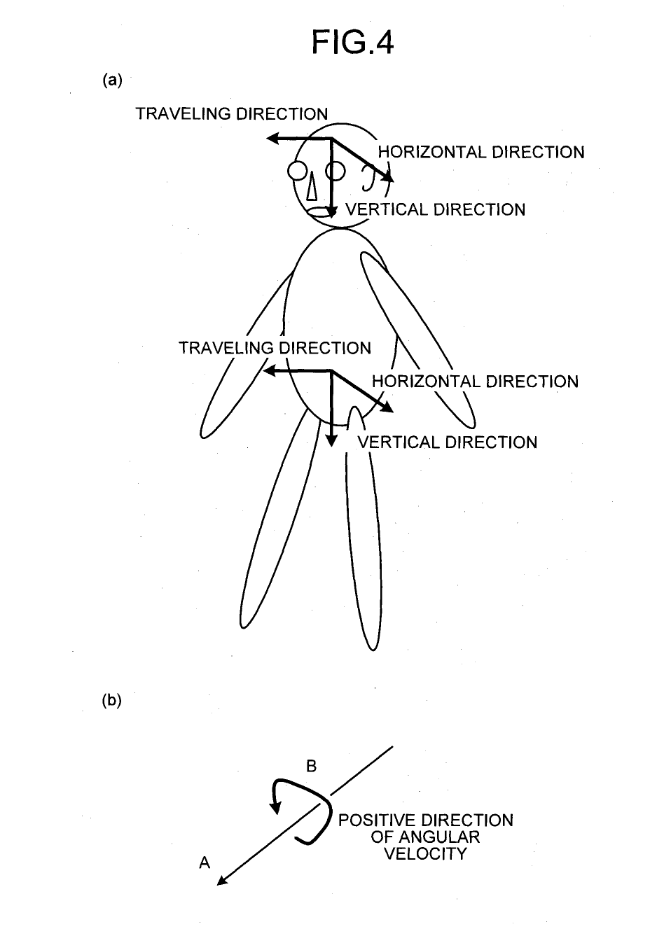

FIGS. 4A and 4B are diagrams illustrating directions detected by the sensors. FIG. 4A illustrates directions detected by the acceleration sensors and the geomagnetic field sensors. As illustrated in FIG. 4A, acceleration components in a traveling direction, the vertical direction, and the horizontal direction and geomagnetic field components are detectable using the acceleration sensors and the geomagnetic field sensors. FIG. 4B illustrates an angular velocity vector A detected by the angular velocity sensors. The positive direction of the angular velocity is indicated by an arrow B. In the embodiment, a projection of the angular velocity vector A in the traveling direction, a projection of the same in the vertical direction, and a projection of the same in the horizontal direction illustrated in FIG. 4A are referred to as an angular velocity component in the traveling direction, a vertical angular velocity component, and a horizontal angular velocity component, respectively.

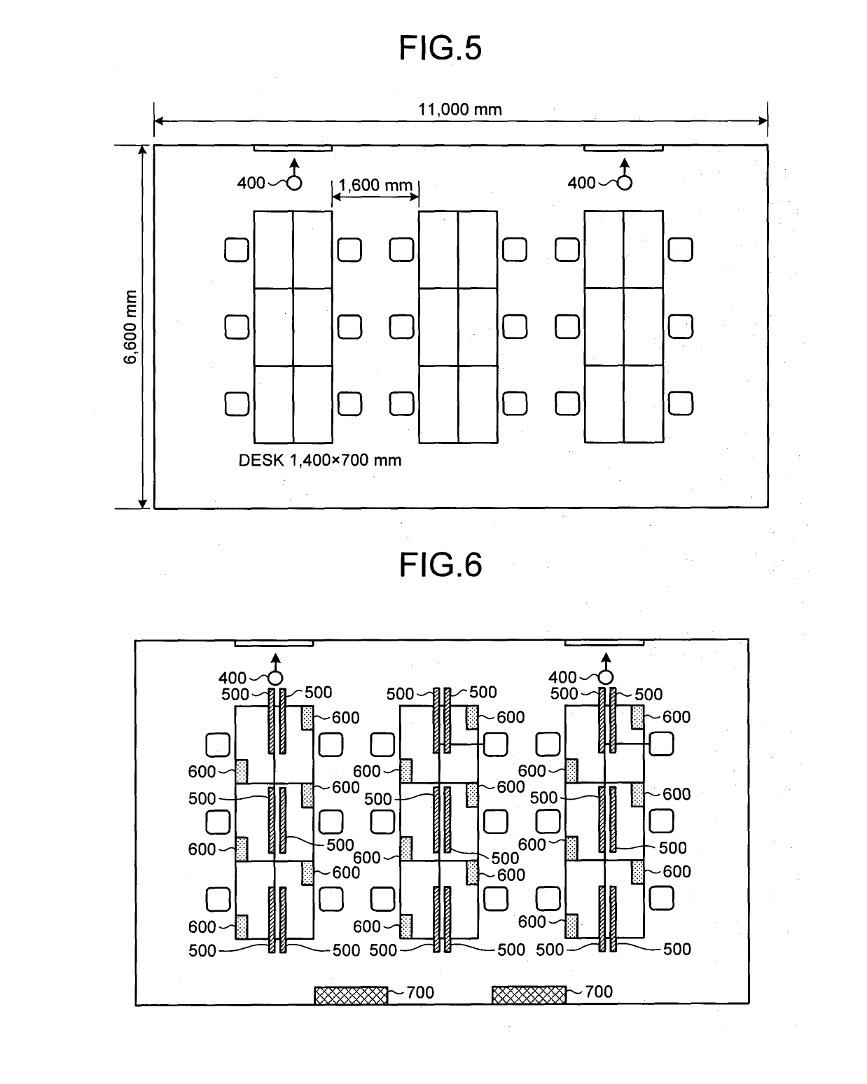

Referring back to FIG. 1, the monitoring cameras 400 that capture images of a control target area are near a top portion or the like of the control target area. Here, the control target area defines area where power control of devices should be conducted. For example, the control target area is one room of offices. FIG. 5 is a diagram illustrating an example of placement of the monitoring cameras 400 in a general office area of an office, which is one of control target areas. In the example illustrated in FIG. 5, the monitoring cameras 400 are arranged, but not limited thereto, at two points near doors in the general office area. The monitoring camera 400 captures images of the control target area and transmits the captured images (captured video) to the location server 100.

Referring back to FIG. 1, power control is performed on a lighting system, an electrical outlet system, an air-conditioning system in the embodiment. More specifically, power control is performed on the plurality of LED lighting devices 500 corresponding to the lighting system, the plurality of electrical outlets 600 corresponding to the electrical outlet system, and the plurality of air conditioners 700 corresponding to the air-conditioning system.

The plurality of LED lighting devices 500, the plurality of electrical outlets 600, and the plurality of air conditioners 700 are in the office, which is the control target area. FIG. 6 is a diagram illustrating an example of placement of the LED lighting devices 500, the electrical outlets 600, and the air conditioners 700 in the general business area of the office, which is one of the control target areas.

The general office area of the office illustrated in FIGS. 5 and 6 contains three groups each consisting of six desks. Each desk is provided with one of the LED lighting devices 500 and one of the electrical outlets 600. By contrast, each of the air conditioners 700 is arranged between every adjacent pair of the groups. This placement of the LED lighting devices 500, the electrical outlets 600, and the air conditioners 700 is only an example, and not limited to the example illustrated in FIG. 6.

A system electric power meter, which is not illustrated in FIGS. 5 and 6, arranged outside the general office area allows acquiring total power consumption of the general office area.

Eighteen workers are performing specific tasks in the general office area illustrated in FIGS. 5 and 6. Each worker enters and exits the general office area by any one of two doors. Although basic operations according to the embodiment are described below by way of example, in which the control target area is limited to the general office area illustrated in FIGS. 5 and 6, the embodiment is applicable to wider variety of layouts and devices. Furthermore, the embodiment is also applicable, by being highly-flexibly adapted, to a wide range of space size and the number of users, and wide range of variations of user attributes and types of task performed by individual users or groups of users. For instance, an office space typically contains, in addition to a general office area, an executive area, a task support area, an information management area, a life support area, a traffic area, and the like. Devices placed in these areas can also be controlled in a similar manner. Application of the embodiment is not limited to indoor space; the embodiment may be applied to outdoor or the like.

The location server 100 and the control server 200 of the embodiment are arranged in, for example, an information management area, out of the general office area of the office illustrated in FIGS. 5 and 6. The power control is not performed on the location server 100 and the control server 200 in the embodiment. However, alternatively, the power control may be performed on these.

The power control is not performed on network devices, such as a Wi-Fi access point, a switching hub, and a router that make up a communication network system, in the embodiment. However, the power control may alternatively be performed on these devices.

Power consumption of these network devices can be calculated by subtracting total power consumption of the LED lighting devices 500, the air conditioners 700, and the electrical outlets 600 from the total power consumption measured by the system electric power meter.

The control server 200 controls each of the plurality of LED lighting devices 500, the plurality of electrical outlets 600, and the plurality of air conditioners 700 by remote control over the network.

More specifically, the control server 200 controls illuminating ranges and light intensities of the LED lighting devices 500 by remote control. To be more specific, the LED lighting devices 500 have on-off switches that are individually remote controllable. The control server 200 wirelessly switches on and off the LED lighting devices 500 via Wi-Fi. Each of the LED lighting devices 500 has a configuration that utilizes an LED lamp with a dimming feature to take advantage of its low power consumption, and allows remote control of the dimming feature via Wi-Fi.

The lighting system is not limited to the LED lighting devices 500. For example, incandescent lamps, fluorescent lamps, or the like can alternatively be used.

The control server 200 switches on and off power sources of the air conditioners 700 by remote control. To be more specific, the air conditioners 700 are configured to be individually remote controllable. Factors to be controlled of the air conditioner 700 include not only power-on/off but also a direction and intensity of air to be blown. In the embodiment, the factors to be controlled do not include the temperature and the humidity of the air to be blown, but may include the temperature and the humidity.

Each of the electrical outlets 600 includes a plurality of sockets. The control server 200 switches on and off power supply to each of the sockets by remote control. More specifically, each of the electrical outlets 600 includes on/off switches that are remote controllable on a socket-by-socket basis. The control server 200 wirelessly controls the on/off switching via Wi-Fi. The number of the sockets contained in each one of the electrical outlets 600 can be an arbitrary number. For example, an electrical outlet made up of four sockets can be used.

In the general office area illustrated in FIG. 6, each desk is provided with one of the electrical outlets 600. Electrical devices (not shown) can be plugged into the electrical outlet 600. Specific examples of the electrical devices include, in addition to a desktop PC and a display device, a notebook PC, a printer apparatus, and battery chargers.

In the embodiment, a display device, for which facing relationship with people matters much, is plugged into one of the sockets of the electrical outlet 600. The control server 200 can control the display device by switching power supply to the socket on and off.

However, when a desktop PC body or a printer apparatus is plugged into a socket of the electrical outlet 600, the control server 200 cannot control the desktop PC body or the printer apparatus by switching power supply to the socket on and off for structural reasons of these apparatuses. Accordingly, power conservation control for the desktop PC body is preferably performed by pre-installing control software that allows placing the desktop PC body in a power conservation mode or a shut-down state via the network. Recovery from the power conservation mode or the shut-down state is to be made by a manual operation performed by a user.

When a battery charger or a notebook PC in a charging mode is plugged into the electrical outlet 600, power supply is preferably continuously set to on for convenience. Note that devices to be plugged into the sockets of the electrical outlets 600 are not limited to the devices described above.

Referring back to FIG. 1, the location server 100 receives the detection data from the sensors to detect positions and motion states of the workers wearing the sensors, and transmits the positions and the motion states to the control server 200. In the embodiment, the motion states include not only active motions, such as walking, standing, sitting in a chair, squatting, and changing an orientation (direction), but also postures, orientations, and the like that result from these motions. More specifically, a standing state resulting from the standing motion, a sitting state resulting from the sitting motion, and the like are also included in the motion states of the embodiment.

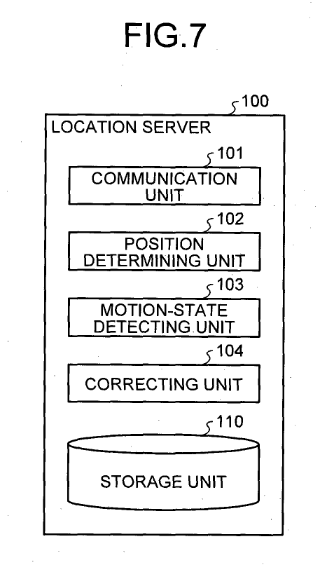

FIG. 7 is a block diagram illustrating a functional configuration of the location server 100. As illustrated in FIG. 7, the location server 100 includes a communication unit 101, a position determining unit 102, a motion-state detecting unit 103, a correcting unit 104, and a storage unit 110.

The storage unit 110 is a storage medium such as a hard disk drive (HDD) or a memory and stores various information necessary for processing performed by the location server 100. The information includes map data about the office, which is the control target area.

The communication unit 101 receives detection data from each of the acceleration sensor, the angular velocity sensor, and the geomagnetic field sensor mounted on the smartphone 300 or the acceleration sensor, the angular velocity sensor, and the geomagnetic field sensor of the sensor group 301, which is independent from the smartphone 300. More specifically, the communication unit 101 receives an acceleration vector from the acceleration sensor, an angular velocity vector from the angular velocity sensor, and a magnetic vector from the geomagnetic field sensor.

The communication unit 101 also receives captured images from the monitoring cameras 400. The communication unit 101 transmits the positions, and the motion states including orientations and postures of the workers, which will be described later, as detected data to the control server 200.

The position determining unit 102 determines the position (absolute position) of each of the workers in a accuracy of shoulder breadth or step length of the worker by analyzing the received detection data. A method, by which the position determining unit 102 determines the position of the worker, will be described in detail later.

The motion-state detecting unit 103 detects the motion state of each of the workers by analyzing the received detection data. In the embodiment, the motion-state detecting unit 103 first detects which one of a resting state and a walking state the motion state of the worker is. When the motion state is the resting state, the motion-state detecting unit 103 further detects an orientation of the worker relative to a device in the control target area, which one of a standing state and a sitting state the posture of the worker is, and the like motion state based on the detection data.

More specifically, when the motion-state detecting unit 103 detects that the worker has entered the area by one of the doors based on the captured images fed from the monitoring cameras 400, the motion-state detecting unit 103 continually determines which one of the walking state and the resting state the motion state of the worker is. This determination is made by using time series data about the acceleration vector and time series data about the angular velocity vector of the detection data continually received from the acceleration sensor, the angular velocity sensor, and the geomagnetic field sensor of the smartphone 300 worn by the worker entering the area or the acceleration sensor, the angular velocity sensor, and the geomagnetic field sensor of the sensor group 301 which is independent from the smartphone 300. Meanwhile, the method for determining which one of the walking state and the resting state the motion state of the worker is using the acceleration vector and the angular velocity vector can be implemented using a technique related to a dead reckoning device disclosed in Japanese Patent No. 4243684, for example. When the worker is determined not to be in the walking state using this method, the motion-state detecting unit 103 can determine that the worker in the resting state.

More specifically, the motion-state detecting unit 103 detects the motion state of the worker as follows, which is similar to a process performed by the dead reckoning device disclosed in Japanese Patent No. 4243684.

The motion-state detecting unit 103 obtains a gravitational acceleration vector from the acceleration vector received from the acceleration sensor and the angular velocity vector received from the angular velocity sensor. The motion-state detecting unit 103 then subtracts the gravitational acceleration vector from the acceleration vector to remove the acceleration in the vertical direction, thereby obtaining time-series remainder-acceleration-component data. The motion-state detecting unit 103 performs principal component analysis of the time-series remainder-acceleration-component data, thereby determining a traveling direction of a walking motion. Furthermore, the motion-state detecting unit 103 searches the vertical acceleration component for a pair of a peak and a valley, and searches the acceleration component in the traveling direction for a pair of a valley and a peak. The motion-state detecting unit 103 calculates a gradient of the acceleration component in the traveling direction.

The motion-state detecting unit 103 then determines whether or not a gradient of the acceleration component in the traveling direction is equal to or greater than a predetermined value at time when the valley of a declining portion from the peak to the valley of the vertical acceleration component is detected. When the gradient is equal to or greater than the predetermined value, the motion-state detecting unit 103 determines that the motion state of the worker is the walking state.

On the other hand, the motion-state detecting unit 103 determines that the motion state of the worker is the resting state when a pair of a valley and a peak is not found in the vertical acceleration component or a pair of a valley and a peak is not found in the acceleration component in the traveling direction, or when the gradient of the acceleration component in the traveling direction at the time when the valley of the declining portion of the vertical acceleration component is detected is smaller than the predetermined value in the process described above.

When the worker is determined to be in the resting state, the position determining unit 102 obtains a relative displacement vector to a position where the worker is determined to be in the resting state using the acceleration vector, the angular velocity vector, and the magnetic vector with respect to a reference position, which is the position of the door. Meanwhile, examples of a method for calculating the relative displacement vector using the acceleration vector, the angular velocity vector, and the magnetic vector include a technique disclosed in Japanese Patent Application Laid-open No. 2011-47950 relating to a process performed by a dead reckoning device.

More specifically, the position determining unit 102 obtains the relative displacement vector as follows, which is similar to the process performed by the dead reckoning device disclosed in Japanese Patent Application Laid-open No. 2011-47950.

That is, the position determining unit 102 calculates a gravity direction vector from the acceleration vector received from the acceleration sensor and the angular velocity vector received from the angular velocity sensor. The position determining unit 102 then calculates an attitude angle of the person as a displacement direction from the gravity direction vector and one of the angular velocity vector and the magnetic vector received from the geomagnetic field sensor. The position determining unit 102 also obtains a gravitational acceleration vector from the acceleration vector and the angular velocity vector, and calculates an acceleration vector produced by the walking motion from the gravitational acceleration vector and the acceleration vector. The position determining unit 102 then detects a walking motion by analyzing the gravitational acceleration vector and the acceleration vector produced by the walking motion. Based on a result of this detection, the position determining unit 102 measures a magnitude of the walking motion based on the gravitational acceleration vector and the acceleration vector produced by the walking motion to obtain a step length, which is a result of the measurement. The position determining unit 102 obtains a relative displacement vector with respect to the reference position by integrating the displacement direction and the step length obtained as described above. Accordingly, the position determining unit 102 detects positions of the worker in real time in the accuracy of a human step length or shoulder breadth, which is approximately 60 centimeters or smaller (more specifically, approximately 40 centimeters or smaller), for example.

When the relative displacement vector has been calculated as described above, the position determining unit 102 determines an absolute position, to which the worker has traveled, based on the relative displacement vector with respect to the door and the map data of the room stored in the storage unit 110.

The position determining unit 102 is capable of determining even at which one of the desks arranged in the general office area the worker is in this way. As a result, the position of the worker can be determined in the accuracy of the human step length or shoulder breadth, which is approximately 60 centimeters or smaller (more specifically, approximately 40 centimeters or smaller), for example.

It does not always hold true that the higher the position accuracy, the better. For instance, in a situation where two or more people are having conversation, they are rarely in contact with each other but generally a certain distance away from each other. In the embodiment, with regard to the accuracy, accuracy of approximately the human shoulder breadth or step length is considered as appropriate; accuracy of approximately the length from the waist to the knees is considered as appropriate in determination as to whether which one of the standing state or the sitting state is taken.

The anthropometric data (Makiko Kouchi, Masaaki Mochimaru, Hiromu Iwasawa, and Seiji Mitani, (2000): Anthropometric database for Japanese Population 1997-98, Japanese Industrial Standards Center (AIST, MITI)) released by the Ministry of Health, Labour and Welfare, contains data about biacromial breadths, which correspond to shoulder breadths, of young adult and elderly men and women. According to this data, an average shoulder breadth of elderly women, which is the smallest among averages, is approximately 35 centimeters (34.8 centimeters), while an average shoulder breadth of young adult men, which is the greatest among the averages, is approximately 40 centimeters (39.7 centimeters). According to the anthropometric data, differences between lengths from waists to knees ((suprasternal heights)−(lateral epicondyle heights)) are approximately 34 to 38 centimeters. Meanwhile, because people take approximately 95 steps to walk 50 meters, step length of moving people can be calculated as approximately 53 (=50/95×10) centimeters. The method for position detection according to the embodiment can achieve the accuracy of approximately the step length. Therefore, based on this data, the embodiment is configured on an assumption that the accuracy of 60 centimeters or smaller, more preferably 40 centimeters or smaller, is appropriate. The data referred to here can be used as reference data in determination of the accuracy; however, this data is based on measurements performed on Japanese people, and accuracy to be employed is not limited to these numerical values.

When, as a result of determination of the position of the worker, the worker is determined to be in the resting state at a seat of a desk, the motion-state detecting unit 103 determines a direction (orientation) of the worker relative to a display device based on a direction of the magnetic vector received from the geomagnetic field sensor. When the worker is in the resting state at the seat of the desk, the motion-state detecting unit 103 determines a posture of the worker, or, more specifically, whether the worker is in the standing state or the sitting state, based on the vertical acceleration component of the acceleration vector.

The determination as to whether the worker is in the standing state or the sitting state can be determined as follows, which is similar to the process performed by the dead reckoning device disclosed in Japanese Patent No. 4243684. A gravitational acceleration vector is calculated from the acceleration vector received from the acceleration sensor and the angular velocity vector received from the angular velocity sensor to obtain the vertical acceleration component. The motion-state detecting unit 103 then detects a peak and a valley of the vertical acceleration component in a manner similar to that of the dead reckoning device disclosed in Japanese Patent No. 4243684, for example.

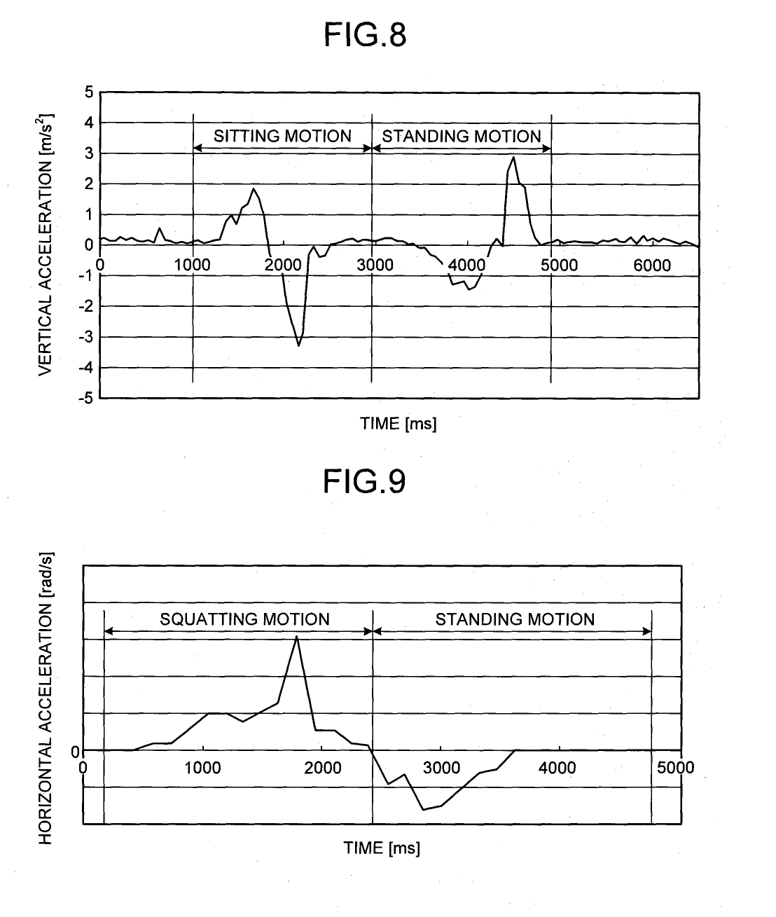

FIG. 8 is a waveform diagram of a vertical acceleration component produced when each of a sitting motion and a standing motion is performed. As illustrated in FIG. 8, a peak-to-valley period of the vertical acceleration component produced by the sitting motion is approximately 0.5 seconds. A valley-to-peak period of the vertical acceleration component produced by the standing motion is approximately 0.5 seconds. Accordingly, the motion-state detecting unit 103 determines whether the worker is in the sitting state or the standing state based on these peak-to-valley/valley-to-peak periods. More specifically, the motion-state detecting unit 103 determines that the motion state of the worker is the sitting state when the peak-to-valley period of the vertical acceleration component is within a predetermined range from 0.5 seconds. The motion-state detecting unit 103 determines that the motion state of the worker is the standing state when the valley-to-peak period of the vertical acceleration component is within a predetermined range from 0.5 seconds.

As described above, the motion-state detecting unit 103 determines whether the motion state of the worker is the standing state or the sitting state, thereby detecting a vertical position of the worker in the accuracy of approximately 50 centimeters or smaller (more specifically, approximately 40 centimeters or smaller).

Furthermore, the motion-state detecting unit 103 can further detect the posture and the motion described below when the worker wears the smartphone 300 equipped with the information device such as the acceleration sensor, the angular velocity sensor, and the geomagnetic field sensor for detecting motions of a worker at the waist, and, in addition thereto, the small headset-type sensor group 301 that includes the acceleration sensor, the angular velocity sensor, and the geomagnetic field sensor at the head separately from the smartphone 300 as in the example illustrated in FIG. 3.

FIG. 9 is a waveform diagram of a horizontal angular velocity component produced when each of a squatting motion and a standing motion is performed. A waveform similar to that of the waveform of the sitting motion and the standing motion illustrated in FIG. 8 is observed in a plot of acceleration data output from the acceleration sensor. However, it is difficult to discriminate between the squatting motion and the standing motion based on only the acceleration data.

For this reason, the motion-state detecting unit 103 discriminates between the squatting motion and the standing motion by, in addition to using the method described above for discriminating between the sitting motion and the standing motion based on the waveform illustrated in FIG. 8, determining whether or not horizontal angular velocity data received from the angular velocity sensor plotted against time fits the waveform illustrated in FIG. 9.

More specifically, the motion-state detecting unit 103 first determines whether or not the peak-to-valley period of the vertical acceleration component based on the acceleration vector received from the acceleration sensor is within a predetermined range from 0.5 seconds.

When the peak-to-valley period of the vertical acceleration component is within the predetermined range from 0.5 seconds, the motion-state detecting unit 103 determines that the motion of the worker is the squatting motion in the following case. That is, a horizontal angular velocity component of the angular velocity vector received from the angular velocity sensor changes to fit the waveform illustrated in FIG. 9 in such manner that the horizontal angular velocity component gradually increases from zero, thereafter sharply increases to reach the peak, then sharply decreases from the peak, and thereafter gradually decreases to become zero again, taking time of approximately 2 seconds.

The motion-state detecting unit 103 determines whether or not the valley-to-peak period of the vertical acceleration component is within the predetermined range from 0.5 seconds. When the valley-to-peak period of the vertical acceleration component is within the predetermined range from 0.5 seconds, the motion-state detecting unit 103 determines that the motion of the worker is the standing motion in the following case. That is, a horizontal angular velocity component of the angular velocity vector received from the angular velocity sensor changes to fit the waveform illustrated in FIG. 9 in such manner that the horizontal angular velocity component decreases in stages from zero to reach the valley and gradually increases from the valley to become zero again, taking time of approximately 1.5 seconds.

The angular velocity vector received from the angular velocity sensor worn at the head is preferably used as the angular velocity vector for use by the motion-state detecting unit 103 in making this determination between the squatting motion and the standing motion. This is because the horizontal angular velocity component based on the angular velocity vector received from the angular velocity sensor worn at the head of the worker distinctively exhibits the waveform illustrated in FIG. 9 related to the squatting motion and the standing motion.

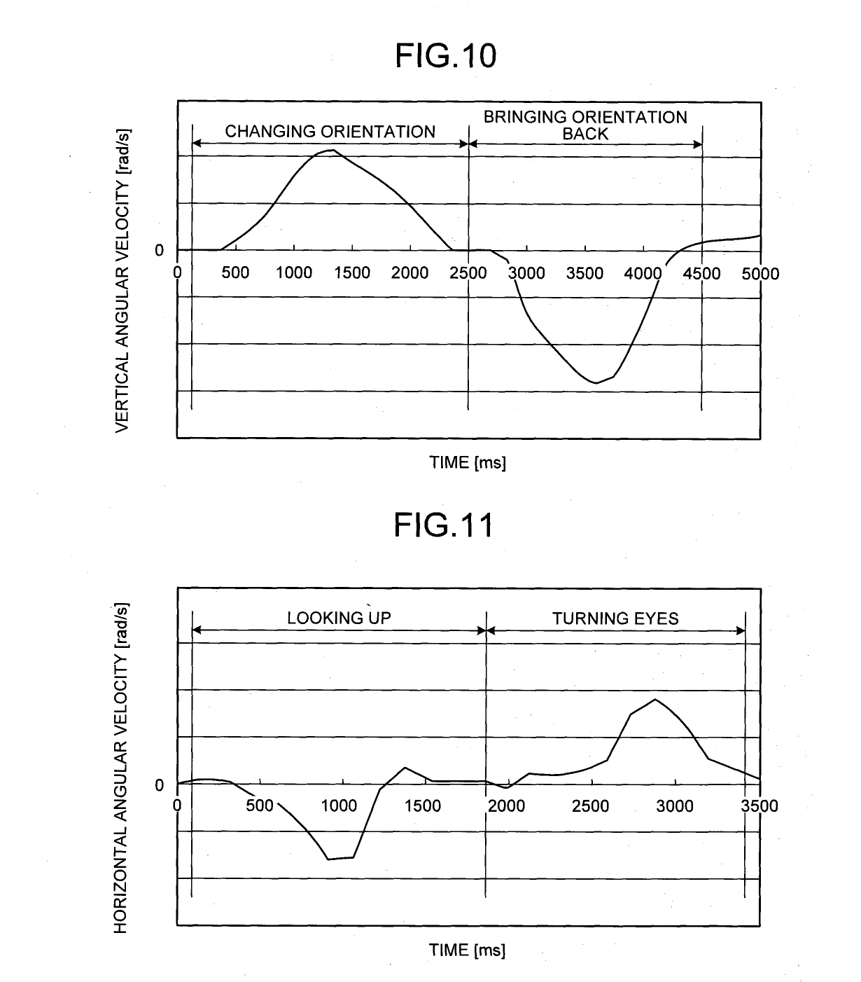

FIG. 10 is a waveform diagram of a vertical angular velocity component produced by a motion of changing the worker's orientation approximately 90 degrees in the resting state. When the vertical angular velocity component is positive, an orientation-changing motion to the right is performed, while when the vertical angular velocity component is negative, an orientation-changing motion to the left is performed.

The motion-state detecting unit 103 determines that the orientation-changing motion to the right is performed when the vertical angular velocity component of the angular velocity vector received from the angular velocity sensor changes with time to fit the waveform illustrated in FIG. 10 in such a manner that the vertical angular velocity component gradually increases from zero to reach a peak and then gradually decreases to become zero again, taking time of approximately 3 seconds.

The motion-state detecting unit 103 determines that the orientation-changing motion to the left is performed when the vertical angular velocity component changes with time to fit the waveform illustrated in FIG. 10 in such a manner that the vertical angular velocity component gradually decreases from zero to reach a valley and then gradually increases to become zero again, taking time of approximately 1.5 seconds.

The motion-state detecting unit 103 determines that a motion of changing an orientation of an entire body to the right or the left is performed when both of the vertical angular velocity component of the angular velocity vector received from the angular velocity sensor at the head and that received from the angular velocity sensor of the smartphone 300 at the waist change with time similarly to the waveform illustrated in FIG. 10 in the determination described above.

On the other hand, the motion-state detecting unit 103 determines that a motion of changing an orientation of only the head to the right or the left is performed in the following case. That is, whereas the vertical angular velocity component of the angular velocity vector received from the angular velocity sensor at the head changes with time similarly to the waveform illustrated in FIG. 10, the vertical angular velocity component of the angular velocity vector received from the angular velocity sensor of the smartphone 300 at the waist changes with time completely differently from the waveform illustrated in FIG. 10. Such a motion can conceivably be made when the worker changes the worker's posture to have conversation with an adjacent worker while staying seated, for example.

FIG. 11 is a waveform diagram of a horizontal angular velocity component of an angular velocity vector received from the angular velocity sensor at the head of a worker that turns the worker's eyes up away from a display in a sitting state.

Assumed below is a situation where the position determining unit 102 has determined that the position of the worker is at a desk and the motion-state detecting unit 103 has determined that the worker at the desk is in the sitting state. In this situation, the motion-state detecting unit 103 determines that a motion (looking-up motion) of turning the worker's eyes up away from the display in the sitting state is performed in the following case. That is, the horizontal angular velocity component of the angular velocity vector received from the angular velocity sensor at the head of the worker changes to fit the waveform illustrated in FIG. 11 in such a manner that the horizontal angular velocity component gradually decreases from zero to reach a valley and then sharply increases to become zero again, taking time of approximately 1 second. The motion-state detecting unit 103 further determines that a motion of turning the worker's eyes back to the display from the state where the worker has turned the eyes up away from the display in the sitting state is performed in the following case. That is, the horizontal angular velocity component changes to fit the waveform illustrated in FIG. 11 in such a manner that the horizontal angular velocity component gradually increases from zero to reach a peak and thereafter gradually decreases to become zero again, taking time of approximately 1.5 seconds.

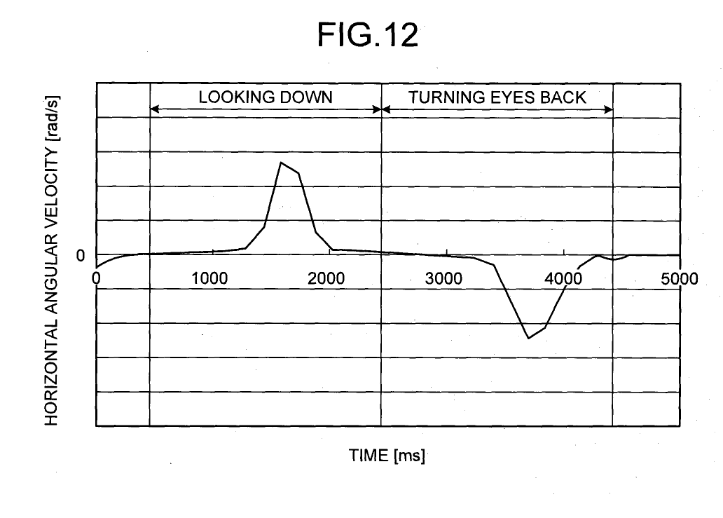

FIG. 12 is a waveform diagram of a horizontal angular velocity component of an angular velocity vector received from the angular velocity sensor at the head of a worker that turns the worker's eyes down away from a display in a sitting state.

Assumed below is a situation where the position determining unit 102 has determined that the position of the worker is at a desk and the motion-state detecting unit 103 has determined that the worker at the desk is in the sitting state. In this situation, the motion-state detecting unit 103 determines that a motion (looking-down motion) of turning the worker's eyes down away from the display in the sitting state is performed in the following case. That is, the horizontal angular velocity component of the angular velocity vector received from the angular velocity sensor at the head of the worker changes to fit the waveform illustrated in FIG. 12 in such a manner that the horizontal angular velocity component sharply increases from zero to reach a peak and then sharply decreases to become zero again, taking time of approximately 0.5 seconds.

The motion-state detecting unit 103 also determines that a motion of turning the worker's eyes back to the display from the state where the worker has turned the eyes down away from the display in the sitting state is performed in the following case. That is, the horizontal angular velocity component changes to fit the waveform illustrated in FIG. 12 in such a manner that the horizontal angular velocity component sharply decreases from zero to reach a valley and thereafter sharply increases to become zero again, taking time of approximately 1 second.

The motion-state detecting unit 103 can make determination of motion states, such as postures and motions that can be daily taken by office workers, using the methods described above. The postures and motions include walking (standing state), standing (resting state), sitting in a chair, squatting during a work, changing an orientation (direction) in the sitting state or the standing state, looking up in the sitting state or the standing state, and looking down in the sitting state or the standing state.

When the technique related to the dead reckoning device disclosed in Japanese Patent No. 4243684 is used, an ascending/descending motion of people in an elevator is also judged using the vertical acceleration component as disclosed in Japanese Patent No. 4243684.

Accordingly, in the embodiment, the motion-state detecting unit 103 can determine highly accurately that a standing motion or a sitting motion, rather than an ascending/descending motion in an elevator detected by the dead reckoning device disclosed in Japanese Patent No. 4243684, is performed when a vertical acceleration component that fits the waveform illustrated in FIG. 8 is detected at a location where no elevator is provided using a function provided by a map matching device disclosed in Japanese Patent Application Laid-open No. 2009-14713, for example.

The correcting unit 104 corrects the position of the worker determined by the position detecting unit 102 and the motion state of the worker detected by the motion-state detecting unit 103 based on the captured images fed from the monitoring cameras 400 and the map data stored in the storage unit 110. More specifically, the correcting unit 104 determines whether or not the position and the motion state of the worker determined as described above are correct by performing image analysis of the captured images fed from the monitoring cameras 400 and the like and/or using the function of the map matching device disclosed in Japanese Patent Application Laid-open No. 2009-14713, for example. When the position or the motion state is determined to be incorrect, the correcting unit 104 corrects the position or the motion state determined to be incorrect above to a correct position or a correct motion state obtained from the captured images and/or using the function of the map matching device.

The correcting unit 104 does not necessarily perform the correction using the captured images fed from the monitoring camera 400. Alternatively, the correcting unit 104 may be configured to perform the correction using restrictive means such as short-range wireless communication, e.g., a radio frequency identification (RFID) or Bluetooth (registered trademark), or optical communication.

In the embodiment, whether a worker is in the sitting state or the walking state, a relative displacement vector from the reference position, a posture (whether the worker is in the standing state or the sitting state), and the like are detected using the technique similar to that of the dead reckoning device disclosed in Japanese Patent No. 4243684 and the dead reckoning device disclosed in Japanese Patent Application Laid-open No. 2011-47950, and the technique similar to that of the map matching device disclosed in Japanese Patent Application Laid-open No. 2009-14713. However, a detection method is not limited thereto. It has been described above that the position of the worker is determined when the motion state of the worker is determined to be the resting state. There can be employed a configuration, in which the position of the worker is similarly determined continually also when the motion state of the worker is the walking state.

There are known other methods that allow detecting a position of people than the described method performed by the location server 100 based on detection data from the acceleration sensor, the angular velocity sensor, and the geomagnetic field sensor. The other methods include: room entry/exit management using IC cards or the like; detecting people using a motion sensor; a method using a wireless LAN; a method using indoor GPS (Indoor MEssaging System (IMES)); a method of performing image processing on images captured by a camera; a method using an active RFID; and a method using visible light communication.

The room entry/exit management using an IC card or the like allows identifying individuals; however, accuracy in position determination is the overall area to be managed, which is considerably low. Accordingly, although information about who are in the area can be acquired, information about activity states of people in the area cannot be acquired.

Detecting people using a motion sensor yields accuracy in position determination of approximately 1 to 2 meters, which is a detection area of the motion sensor; however, individuals cannot be identified. Furthermore, it is necessary to place and distribute a large number of motion sensors across an area to obtain information about activity states of people in the area.

The method using a wireless LAN is performed by measuring distances between a single wireless LAN terminal carried by people and a plurality of LAN access points placed in an area and determining a position of the person in the area using the principle of triangulation. This method allows identifying individuals; however, because accuracy in position determination largely depends on environment, accuracy in position determination is generally 3 meters or greater, which is relatively low.

The method using indoor GPS is performed by placing a transmitter, which is dedicated to this purpose, that emits radio waves of the same frequency band as that of GPS satellites inside a building and causing the transmitter to transmit a signal, in which position information is embedded at a portion originally for use by a GPS satellite to transmit time information. The signal is received by a receiver terminal carried by people inside the building. As a result, the position of the person inside the building is determined. This method allows identifying individuals; however, accuracy in position determination is approximately 3 to 5 meters, which is relatively low. Moreover, the necessity of installing the transmitter, which is dedicated to this purpose, increases cost for introducing this method.

The method of performing image processing on images captured by a camera yields accuracy in position determination of several tens of centimeters, which is relatively high; however, it is difficult to identify individuals. For this reason, in the location server 100 of the embodiment, captured images fed from the monitoring camera 400 are used only in correcting a position and a motion state of a worker.

The method using an active RFID is performed by determining a position of people by causing the person to carry an RFID tag with an internal battery and reading information from the RFID tag using a tag reader. This method allows identifying individuals; however, because accuracy in position determination largely depends on environment, accuracy in position determination is generally 3 meters or greater, which is relatively low.

The method using visible light communication allows identifying individuals and, furthermore, yields accuracy in position determination of several tens of centimeters, which is relatively high. However, people cannot be detected at a place where visible light is shielded; moreover, it is difficult to maintain stability in detection accuracy because there are a plenty of sources of noise and interference, such as natural light and other visible light.

In contrast to these techniques, the method performed by the location server 100 of the embodiment allows not only identifying individuals but also yields high accuracy in position determination of approximately the shoulder breadth or the step length of humans. Furthermore, the method allows detecting not only positions of people but also motion states of the people. More specifically, the following postures and motions that can be daily taken by office workers can be detected as human motion states by the method performed by the location server 100 of the embodiment. The motion states include walking (standing state), standing (resting state), sitting in a chair, squatting during a work, changing an orientation (direction) in the sitting state or the standing state, looking up in the sitting state or the standing state, and looking down in the sitting state or the standing state.

Accordingly, in the embodiment, the location server 100 is configured to detect positions and motion states of workers in an office, which is the control target area, using the method described above based on detection data from the acceleration sensor, the angular velocity sensor, and the geomagnetic field sensor of the smartphone 300 or the sensor group 301. However, a method for detecting positions and motion states of workers in an office, which is the control target area, is not limited to the method described above performed by the location server 100. For example, the positions and the motion states of the workers may alternatively be detected by one of or a combination of a plurality of the other methods described above. Further alternatively, the positions and the motion states of the workers may be detected by a combination of the method described above performed by the location server 100 and one or more of the other methods described above.

The control server 200 is described in detail below. The control server 200 controls each of the plurality of LED lighting devices 500, the plurality of electrical outlets 600, and the plurality of air conditioners 700 placed in the office, which is the control target area, by remote control over the network based on positions and motion states of workers in the office.

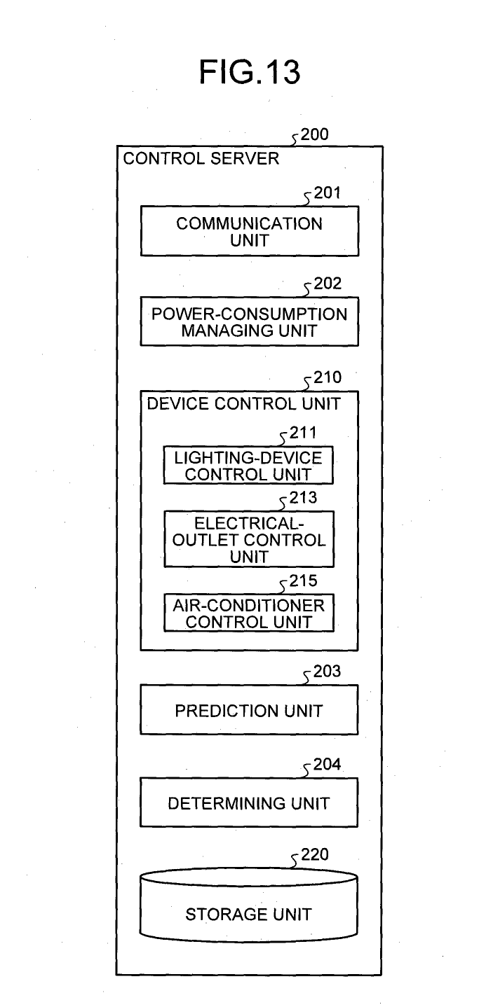

FIG. 13 is a block diagram illustrating a functional configuration of the control server 200 according to the embodiment. As illustrated in FIG. 13, the control server 200 according to the embodiment includes a communication unit 201, a power-consumption managing unit 202, a device control unit 210, an prediction unit 203, a determining unit 204, and a storage unit 220.

The storage unit 220 is a storage medium, such as an HDD or a memory, and stores various types of information necessary for processing by the control server 200. The information includes position data about each of the controlled devices (the plurality of LED lighting devices 500, the plurality of electrical outlets 600, and the plurality of air conditioners 700) arranged in the office, which is the control target area, and a control table for use in the power conservation control, which will be described later.

The communication unit 201 receives detected data indicating a position and a motion state (orientation, posture, and/or the like) of each of workers from the location server 100. The communication unit 201 also receives power consumptions from the plurality of LED lighting devices 500, electrical devices plugged into the plurality of electrical outlets 600, and the plurality of air conditioners 700. The communication unit 201 transmits control signals for use in power control to the plurality of LED lighting devices 500, the plurality of electrical outlets 600, and the plurality of air conditioners 700.

The power-consumption managing unit 202 manages the power consumptions received from the plurality of LED lighting devices 500, the electrical devices plugged into the plurality of electrical outlets 600, and the plurality of air conditioners 700. The power-consumption managing unit 202 can acquire and manage information about total power consumption of the entire office, which is the control target area, by acquiring not only the power consumptions on a per-controlled-device basis but also a total of system-by-system power consumptions from the system electric power meter described above. The information about power consumptions managed by the power-consumption managing unit 202 can be displayed on a display to implement what is called as “information presentation in visual form” or used in determination as to whether or not to perform the power conservation control, which will be described later.

The device control unit 210 includes a lighting-device control unit 211, an electrical-outlet control unit 213, and an air-conditioner control unit 215. The lighting-device control unit 211 controls the LED lighting devices 500 based on the positions and the motion states (orientations, postures, and/or the like) of the workers. More specifically, the lighting-device control unit 211 transmits a control signal to one of the LED lighting devices 500, which is, for example, near a position of a worker via the communication unit 201. This control signal sets an illuminating range and light intensity of the LED lighting device 500 to a range smaller than a predetermined range and a value higher than a predetermined threshold value, respectively, when the worker is in the sitting state. As a result, the illuminating range and the light intensity can be adjusted to the range and the value appropriate for a precision work for the worker working in the sitting state.

On the other hand, when the worker is in the standing state, the lighting-device control unit 211 transmits to the LED lighting device 500 a control signal that sets the illuminating range and the light intensity to a range larger than the predetermined range and a value lower than the predetermined threshold value, respectively, via the communication unit 201. As a result, the illuminating range and the light intensity can be adjusted to the range and the value that allows the worker in the standing state to view the entire general office area, for example.

The electrical-outlet control unit 213 controls power-on/off of the sockets of the electrical outlets 600 based on the positions and the motion states (orientations, postures, and/or the like) of the workers. More specifically, for example, when a worker is in the sitting state and an orientation of the worker relative to a display device plugged into one of the electrical outlets 600 near the position of the worker is a facing orientation, the electrical-outlet control unit 213 transmits a control signal that causes a socket, into which the display device is plugged, of the electrical outlet 600 to be switched on via the communication unit 201.

On the other hand, when the worker is in the standing state or the orientation relative to the display device is a back-facing orientation, the electrical-outlet control unit 213 transmits a control signal that causes the socket, into which the display device is plugged, of the electrical outlet 600 to be switched off via the communication unit 201.

The reason why power control is performed depending on the orientation of the worker relative to the display device is as follows: facing relationship with the worker matters much for the display device, and the display device can be judged to be being used when the orientation is the facing orientation. The display device can be judged to be being used when the posture of the worker is the sitting state. In the embodiment, power control is performed taking actual usage of devices into consideration in this way. Accordingly, finer control can be performed as compared with power control that is performed depending on only a distance between the worker and the device.

Moreover, the electrical-outlet control unit 213 of the embodiment performs power control of the desktop PC body and the display device in accordance with individual recognition information of the worker. For instance, personal authentication information of a worker is sent from the smartphone 300 carried by the worker to the location server 100, and then transmitted from the location server 100 to the control server 200. The control server 200 can perform power control of a desktop PC body and a display device used exclusively only by the worker by utilizing this personal authentication information.

The air-conditioner control unit 215 controls power-on/off of the air conditioners 700 based on the positions of the workers. More specifically, the air-conditioner control unit 215 transmits a control signal that switches on or adjusts intensity or direction of air to be blown by one of the air conditioners 700 near a position of a worker via the communication unit 201, for example.

Total power consumption amount of the control target area can be reduced by controlling the devices to be controlled depending on the positions and the motion states of the workers as described above. However, there can be a case where further reduction in power consumption is required even when such power control as that described above is performed. There can also be an emergency situation of unexpected power supply shortage or a case where it is required to reduce peak power to positively cut down electricity cost. In light of the above, the device control unit 210 of the embodiment performs the power conservation control to further reduce total power consumption of the entire office in the following cases. The cases include a case where it is predicted that total power consumption amount of the entire office that is defined as an integral value over a predetermined period (e.g., a period from starting time to quitting time of the office) will exceed a preset target value and a case where it is predicted that a peak value of total power of the entire office, which is the control target area, will exceed a preset upper limit value.

The prediction unit 203 predicts whether or not the total power consumption amount of the entire office over the predetermined period (e.g., the period from starting time to quitting time of the office) will exceed the preset target value based on the information about the power consumptions managed by the power-consumption managing unit 202. For example, the prediction unit 203 estimates total power consumption amount of the entire office over a period from starting time to quitting time of the office and determines whether or not the estimated total power consumption amount of the entire office will exceed the target value. The prediction unit 203 also predicts whether or not a peak value of total power of the entire office will exceed the preset upper limit value based on the information about the power consumptions managed by the power-consumption managing unit 202. For example, the prediction unit 203 estimates a peak value of total power of the entire office from history data indicating per-time-zone operation patterns of the devices and a current operation pattern of the devices, and determines whether or not the estimated peak value will exceed the upper limit value. When the prediction unit 203 predicts that the total power consumption amount of the entire office will exceed the target value or that the peak value will exceed the upper limit value, the prediction unit 203 requests the determining unit 204 to assign priorities to workers. Simultaneously, the prediction unit 203 requests the device control unit 210 to perform the power conservation control.

When requested by the prediction unit 203 to assign priorities to the workers, the determining unit 204 assigns a priority in reducing power consumption amount of a device associated with a worker to every worker, of which position and motion state are detected by the location server 100 at this point in time, based on at least one of the position and the motion state of the worker. The device associated with the worker may include, for instance, one of the LED lighting devices 500 and one of the air conditioners 700 near the detected position of the worker, or a desktop PC body and a display device used exclusively only by the worker. Power consumption of a device associated with a worker assigned with a higher priority is reduced with priority over a device associated with a worker assigned with a lower priority. In this way, the determining unit 204 assigns priorities in reducing power consumptions of devices to workers that use the devices or receive benefit from the devices rather than to the controlled devices. The priorities are assigned by taking dynamic behavior of workers in the office, which is the control target area, into consideration in such a manner that the less the likelihood that reduction in power consumption of a device results in a decrease in productivity of a worker, the higher the priority assigned to the worker. In this assignment, the position and the motion state of the worker are used as indexes for keeping track of dynamic behavior of the worker. More specifically, it is possible to guess where the worker is and what the worker is doing from the position and the motion state of the worker. Accordingly, priorities are assigned to the workers based on either or both of the positions and the motion states of the workers.

When requested from the prediction unit 203 to perform the power conservation control, the device control unit 210 performs the power conservation control to further reduce the total power consumption of the entire office based on the priorities assigned to the workers by the determining unit 204. The power conservation control performed by the device control unit 210 will be descried in detail later.

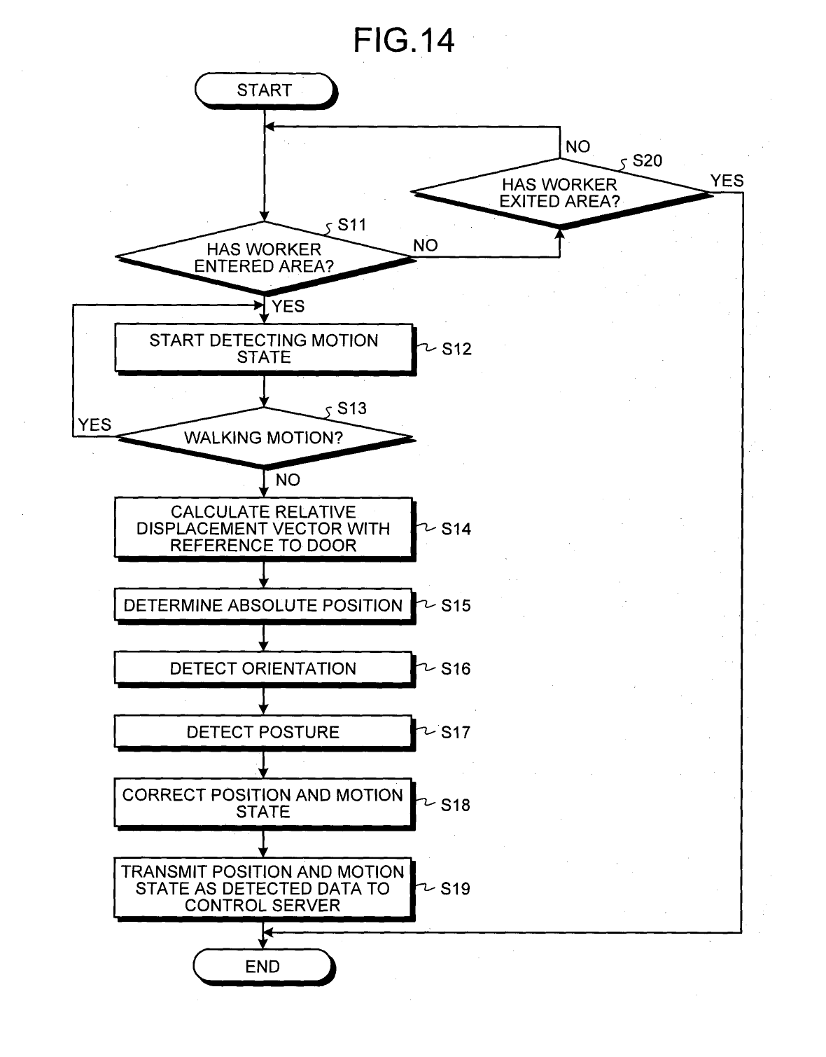

Basic operations of the device control system of the embodiment configured as described above are described in detail below. FIG. 14 is a flowchart illustrating a procedure for a detection process to be performed by the location server 100 of the embodiment. The detection process in this flowchart is performed for each of the plurality of smartphones 300. FIG. 14 illustrates the procedure for the detection process to be performed by the location server 100 in a case where a worker enters the general office area illustrated in FIGS. 5 and 6. The location server 100 also performs a detection process by a similar procedure when a worker makes activity in a control target area other than the general office area.

Aside from the detection process in this flowchart, the location server 100 receives detection data (acceleration vectors, angular velocity vectors, and magnetic vectors) at predetermined time intervals from the acceleration sensors, the angular velocity sensors, and the geomagnetic field sensors mounted on the plurality of smartphone 300 or other acceleration sensors, angular velocity sensors, and geomagnetic field sensors than those of the smartphones 300. The location server 100 also receives captured images from the plurality of monitoring cameras 400.

First, the location server 100 determines whether or not a worker has entered the general office area, which is the control target area, based on captured images of a door that is opened or closed, for example (Step S11). When no worker has entered the general office area (No in Step S11), the location server 100 determines whether or not a worker has exited the general office area (Step S20). When no worker has exited the general office area (No in Step S20), processing goes back to Step S11 to repeat the process. When a worker has exited the general office area (Yes in Step S20), the detection process ends. On the other hand, when a worker has entered the general office area (Yes in Step S11), the motion-state detecting unit 103 starts detecting a motion state of the worker using the method described above (Step S12). The motion-state detecting unit 103 determines whether or not the motion state of the worker is the walking state (Step S13). The motion-state detecting unit 103 repeatedly performs motion state detection over a period, in which the motion state is the walking state (Yes in Step S13).

On the other hand, when the motion state of the worker is not the walking state (No in Step S13), the motion-state detecting unit 103 determines that the motion state of the worker is the resting state. The position determining unit 102 calculates a relative displacement vector with respect to the door, serving as the reference position, using the method described above (Step S14).

The position determining unit 102 determines a position (an absolute position in the general office area) of the worker in the resting state from the map data about the general office area stored in the storage unit 110 and the relative displacement vector with respect to the door (Step S15). Thus, the position determining unit 102 can determine even at which one of the desks arranged in the general office area the worker is. As a result, the position of the worker is determined in the accuracy of the shoulder breadth (which is approximately 60 centimeters or smaller; more specifically, approximately 40 centimeters or smaller) of the worker.

Subsequently, the motion-state detecting unit 103 detects a direction (orientation) of the worker relative to a display device as the motion state of the worker in the resting state using a magnetic vector received from the geomagnetic field sensor (Step S16).

Subsequently, the motion-state detecting unit 103 detects a posture, which is either the sitting state or the standing state, as the motion state of the worker using the method described above (Step S17). Thus, the motion-state detecting unit 103 detects a vertical position of the worker in the accuracy of approximately 50 centimeters or smaller (more specifically, approximately 40 centimeters or smaller).

The motion-state detecting unit 103 may further detect, as the motion state of the worker, either the squatting motion or the standing motion, either the motion of changing an orientation in the sitting state or the motion of bringing the orientation back, either the motion of turning eyes up in the sitting state or the motion of turning eyes back, and either the motion of turning eyes down in the sitting state or the motion of turning eyes back is performed.

Subsequently, the correcting unit 104 determines whether or not the determined position and the detected motion state (orientation, posture, and/or the like) require correction as described above, and, if necessary, performs correction (Step S18).

The communication unit 101 transmits the determined position and the detected motion state (if corrected, the corrected position and/or the corrected motion state) to the control server 200 as detected data (Step S19).

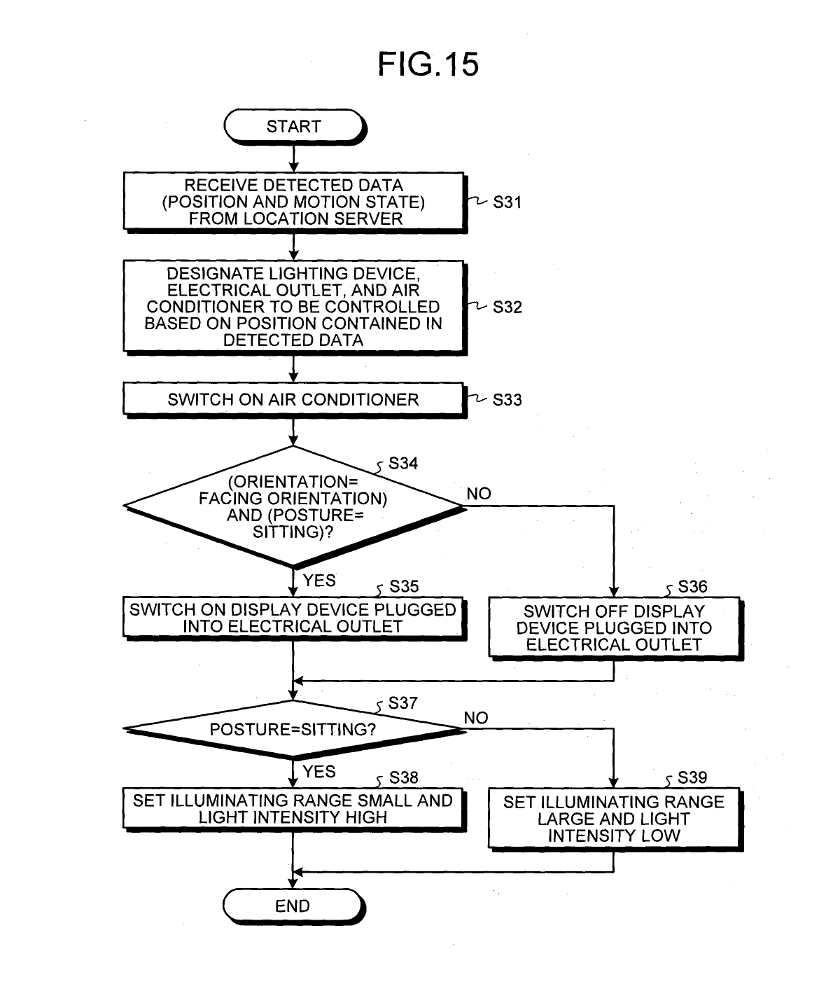

A device control process to be performed by the control server 200 is described below. FIG. 15 is a flowchart illustrating a procedure for the device control process of the embodiment. Note that described below is a procedure for basic processing of the device control process of the embodiment excluding the power conservation control, and a procedure for the power conservation control will be described later.

First, the communication unit 201 receives the position and the motion state of the worker as the detected data from the location server 100 (Step S31). Subsequently, the control units 211, 213, and 215 of the device control unit 210 designates one of the LED lighting devices 500, one of the electrical outlets 600, and one of the air conditioners 700 as devices to be controlled based on the position contained in the received detected data (Step S32).

More specifically, the lighting-device control unit 211 designates one of the LED lighting devices 500 corresponding to a desk closest to the position of the worker as the device to be controlled by reference to the position data stored in the storage unit 220. The electrical-outlet control unit 213 also designates one of the electrical outlets 600 at the desk closest to the position of the worker as the device to be controlled by reference to the position data stored in the storage unit 220. The air-conditioner control unit 215 also designates one of the air conditioners 700 near the position of the worker as the device to be controlled by reference to the position data stored in the storage unit 220.

Subsequently, the air-conditioner control unit 215 performs control of switching on the designated air conditioner 700 (Step S33).

Subsequently, the electrical-outlet control unit 213 determines whether or not the motion state contained in the received detected data indicates that the orientation and the posture of the worker are the facing orientation and the sitting state, respectively (Step S34). When the orientation and the posture of the worker are the facing orientation and the sitting state, respectively (Yes in Step S34), the electrical-outlet control unit 213 performs control of switching on a socket, into which a display device is plugged, of the electrical outlet 600 designated in Step S32 (Step S35).

On the other hand, when the orientation of the worker is the back-facing orientation or when the posture of the worker is the standing state in Step S34 (No in Step S34), the electrical-outlet control unit 213 performs control of switching off the socket, into which the display device is plugged, of the electrical outlet 600 designated in Step S32 (Step S36).

Subsequently, the lighting-device control unit 211 determines whether or not the motion state contained in the received detected data indicates that the posture of the worker is the sitting state again (Step S37). When the posture of the worker is the sitting state (Yes in Step S37), the lighting-device control unit 211 performs control of setting an illuminating range and a light intensity of the LED lighting device 500 designated in Step S32 to a range smaller than the predetermined range and a value higher than the predetermined threshold value, respectively (Step S38).

On the other hand, when the posture of the worker is the standing state in Step S37 (No in Step S37), the lighting-device control unit 211 performs control of setting the illuminating range and the light intensity of the LED lighting device 500 designated in Step S32 to a range larger than the predetermined range and a value lower than the predetermined threshold value, respectively (Step S39).

The control units 211, 213, and 215 of the device control unit 210 may be configured to perform other control operations than those described above on each of devices to be controlled.

The control units 211, 213, and 215 of the device control unit 210 may be configured so as to control the devices to be controlled differently depending on which one of the squatting motion and the standing motion, which one of the motion changing an orientation in the sitting state and the motion of bringing the orientation back, which one of the motion (looking-up motion) of turning the worker's eyes up in the sitting state and the motion of turning the eyes back, and which one of the motion (looking-down motion) of turning the worker's eyes down in the sitting state and the motion of turning the eyes back the motion state of the worker is.

Specific examples of motions, devices to be controlled, and control methods that can be involved in such detection as that described above are described below. Each of the motions is a motion that can occur when a worker is sitting at a desk. Examples of the devices to be controlled include a PC, a display device for the PC, a desk lamp, and a desk fan as an individual air conditioner.

For example, the electrical-outlet control unit 213 can be configured to switch off a socket, into which the PC is plugged, when it is determined from the motion state contained in the received detected data that a squatting motion of a worker at a desk lasts for a predetermined period of time or longer. For another example, the device control unit 210 can be configured to include a mode control unit that controls modes of devices so as to bring the display device of the PC into a standby mode.

The mode control unit can be configured to bring the PC to the standby mode in a case where, after the standing motion is detected in the worker in the sitting state, the standing state lasts for a predetermined period of time or longer. The electrical-outlet control unit 213 can be configured to switch off a socket, into which the display device is plugged, concurrently when the PC is brought to the standby mode.

Examples of control to be performed in response to an orientation-changing motion include the following. A conceivable situation in which, after a change in orientation of a head or an upper body is detected in a worker sitting at a desk, this state lasts for a predetermined period of time or longer, is that the worker is making conversation with another worker at an adjacent desk or the like. The electrical-outlet control unit 213 and the mode control unit can be configured to put the PC, the display device, and a lighting device, such as a desk lamp, on standby or switches them off in such a situation. The electrical-outlet control unit 213 and the mode control unit can be configured to switch on the PC, the display device, and the lighting device, such as the desk lamp, when it is detected the worker's orientation and posture have been brought back.

A worker who reads a document at a desk is likely to perform the looking-down motion. A worker who is trying to come up with an idea or thinking is likely to perform the looking-up motion. Accordingly, the electrical-outlet control unit 213 and the mode control unit can be configured to perform control to bring the PC to the standby mode or switch off the display device when the looking-up motion or the looking-down motion is continuously detected for a predetermined period of time or longer. Furthermore, the electrical-outlet control unit 213 may be configured not to switch off the desk lamp when the looking-down motion is detected.

As described above, in the embodiment, power control of devices is performed by determining positions of workers in the accuracy of shoulder breadth and detecting motion states (orientations, postures, and/or the like) of the workers. Accordingly, power control of the devices can be performed with finer accuracy, and further power conservation and energy saving can be achieved while maintaining comfort of workers and increased task productivity.

More specifically, according to the present embodiment, it is possible to individually control devices including a device exclusively used by a worker, and a lighting device, an air conditioner, and OA equipment near a desk, at which the worker sits, depending on a motion state of each of the workers. Furthermore, information about per-worker power consumption can be obtained.

Conventional techniques can implement what is called as “representation in visual form” of power consumption of a building, an office, an entire factory, or an entire office, but do not indicate what power saving action is required of each person. Accordingly, each person is less likely to be conscious of power conservation unless otherwise a stringent situation, e.g., a situation where power consumption exceeds a total target value or an available power supply, occurs. This makes it difficult to perform power conservation continuously. However, according to the embodiment, it is possible to achieve power conservation while maintaining comfort of workers performing tasks to prevent a decrease in productivity of the tasks.

The embodiment also makes it possible to achieve greater power conservation by performing automatic control of devices not only in coordination between workers and devices but also in coordination between devices.

The power conservation control performed by the device control unit 210 of the control server 200 is described below by way of a specific example. As described above, the device control unit 210 of the embodiment performs the power conservation control to further reduce total power consumption of the entire office in the following cases. The cases include a case where it is predicted that total power consumption amount of the entire office, which is the control target area, over the predetermined period (e.g., a period from starting time to quitting time of the office) will exceed the preset target value and a case where it is predicted that a peak value of total power of the entire office, which is the control target area, will exceed the preset upper limit value.

Typical conventional control performed to reduce total power consumption amount or peak power of an entire office is stopping a device that consumes large power, such as an air conditioner, by highest priority. Examples of such a control method include an intermittent operation method of operating an air conditioner that consumes large power by, for example, stopping the air conditioner for approximately 30 minutes and a method of forcibly stopping the air conditioner over a set period of time. However, such a method presents many problems. For example, task productivity can decrease in some season, in which workers performing the tasks in the office are required to endure discomfort. In contrast, the power conservation control performed by the device control unit 210 reduces power consumptions of devices so as to prevent total power consumption amount of the entire office over the predetermined period from exceeding the preset target power value or to prevent a peak value of total power of the entire office from exceeding the preset upper limit value. Furthermore, comfort of workers performing tasks is maintained so that a decrease in productivity in the tasks is reduced. Thus, power control of the devices is performed placing priority on dynamic behavior of the workers.

The power conservation control performed by the device control unit 210 of the embodiment is described in detail below by way of a specific example. First, an example of a layout of the entire office, which is assumed as the control target area in the specific example, is described below.

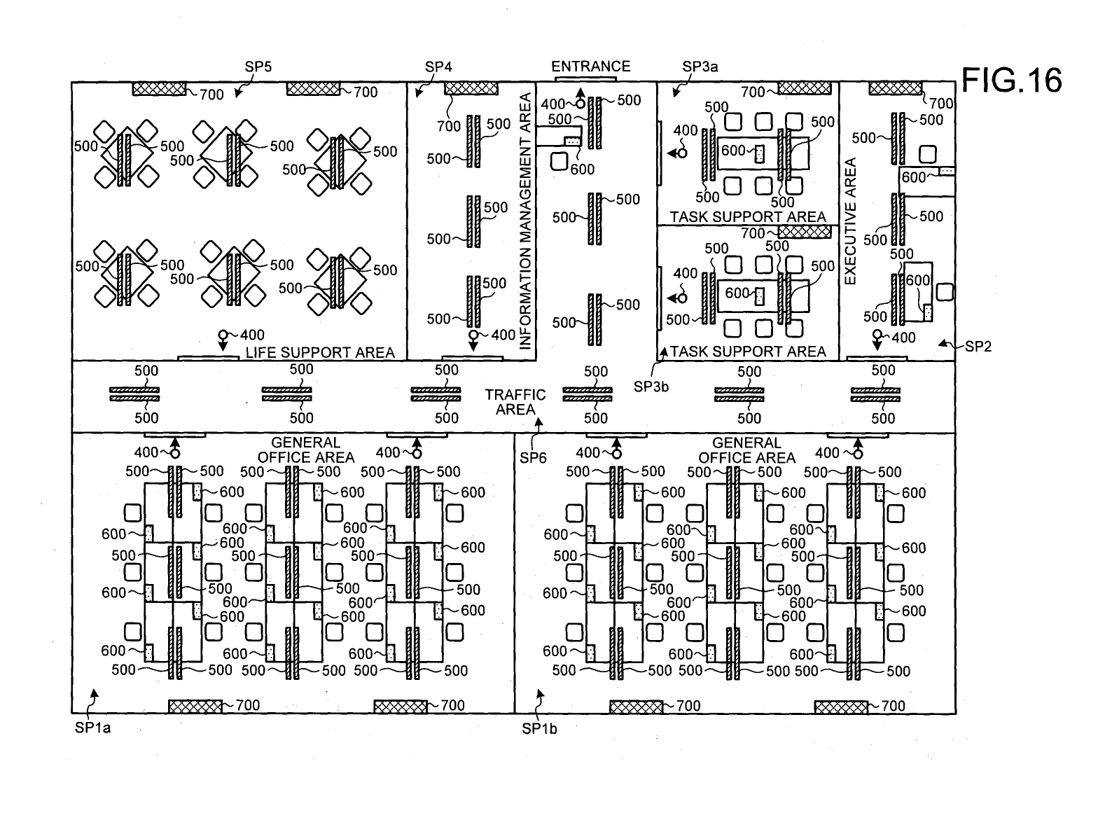

FIG. 16 is a diagram illustrating an example of layout of the entire office and placement of the LED lighting devices, the electrical outlets, and the air conditioners in each area. An office space can be generally categorized into six areas, which are general office areas SP1a and SP1b, an executive area SP2, task support areas. SP3a and SP3b, an information management area SP4, a life support area SP5, and a traffic area SP6 as illustrated in FIG. 16.

The general office areas SP1a and SP1b are areas that occupy the largest area in the office and provide functions directly necessary for general tasks.

The executive area SP2 is a place exclusively used by directors and includes a director's room, a board room, and the like. When director's desks are in the general office area SP1a, SP1b, it is unnecessary to consider about the executive area SP2.

The task support areas SP3a and SP3b are places for supporting tasks and may include a meeting room, a reception room, a reception desk zone, a place where OA equipment, such as a copier and a facsimile, are placed, and the like.

The information management area SP4 is a place for managing information necessary to perform tasks and includes a repository for storing documents and the like, server room where various types of servers are placed, and the like.

The life support area SP5 is an area related to off-the-job activities for use by workers in spare moments from tasks and includes an employee cafeteria, a smoking room, and a lounge, and the like.

The traffic area SP6 is an area of passages and aisles, through which workers move.

In the description below, it is assumed that an office, which is the control target area, has the layout illustrated in FIG. 16 and devices, on which the power conservation control is to be performed, are limited to the LED lighting devices 500 and the air conditioners 700. The power conservation control is performed on the LED lighting devices 500 and the air conditioners 700 in a manner to bring the LED lighting device 500 and the air conditioner 700 near a worker to a status (power consumption level) determined in advance depending on a position and a motion state of the worker.

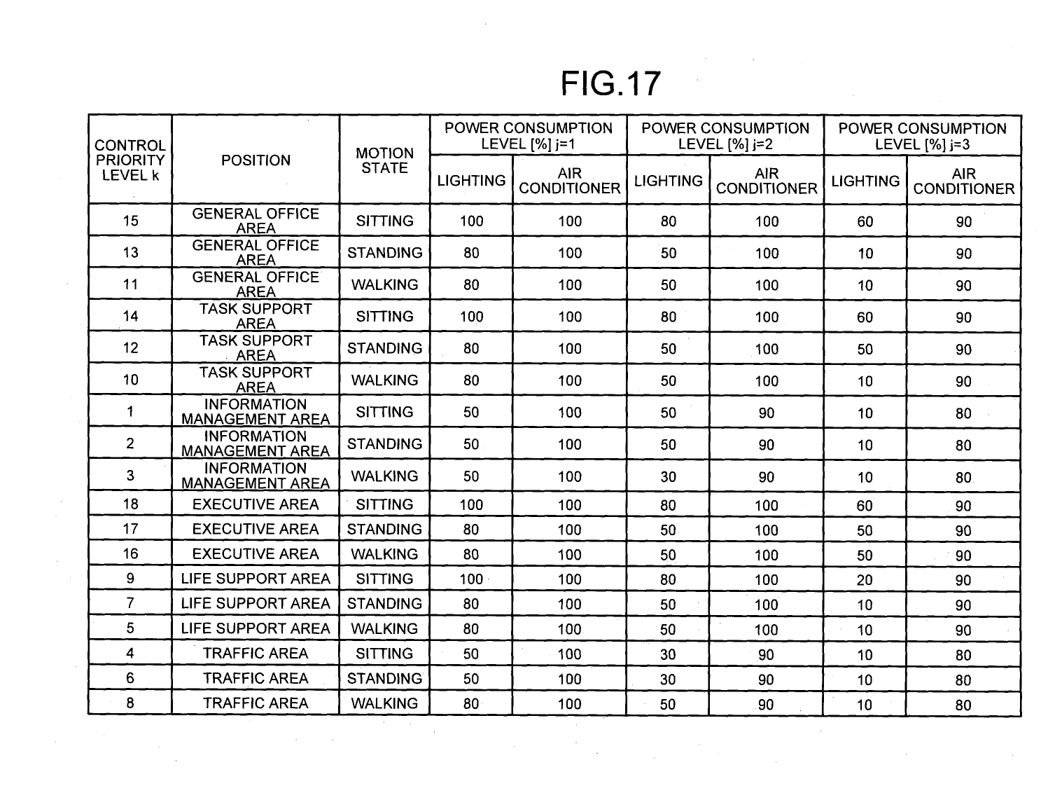

FIG. 17 is a diagram illustrating an example of a control table for use in the power conservation control. This control table is stored in the storage unit 220 of the control server 200 and consulted by the determining unit 204 and the device control unit 210 during the power conservation control.

The control table illustrated in FIG. 17 defines control priority levels and power consumption levels of controlled devices against between conditions. The condition is a combination of position and motion state of a worker. The control priority level indicates a priority level in reducing power consumptions of devices and is ranked in such a manner that the less the likelihood that reducing power consumptions results in a decrease in task productivity, the higher the control priority level. In the power conservation control, the determining unit 204 can assign priority to each worker based on the control priority levels associated with positions and motion states of all the workers in the office. In other words, the priority assigned by the determining unit 204 to each of the workers corresponds to the control priority level presented in the control table.

The power consumption level indicates to what extent power consumption of the controlled device is to be reduced depending on a condition, which is a combination of position and motion state of a worker. The power consumption level is expressed in percentage of target power consumption of the device to power consumption of the device in a not-yet-controlled state. The power consumption level for each of the conditions is divided into three stages in the control table illustrated in FIG. 17. In the power conservation control, the device control unit 210 can perform power control on each of devices in order of decreasing priority assigned to the workers in accordance with a power consumption level associated with a position and a motion state of a worker corresponding to the device (in this example, the LED lighting device 500 and the air conditioner 700 near the worker). At this time, the device control unit 210 can perform power control of the device stage by stage by reference to the three stages of the power consumption level.

More specifically, the device control unit 210 performs power control on the devices in order of decreasing priority, in which a device associated with a worker of high priority is first, so as to bring each of the devices to a status of a first stage of the power consumption level. In the following case, the device control unit 210 performs power control on the devices in order of decreasing priority, in which the device associated with the worker of high priority is first, so as to bring each of the devices to a status of a second stage of the power consumption level; the case is when it is predicted that total power consumption amount of the entire office over the predetermined period will exceed the target value or that a peak value of total power of the entire office will exceed the upper limit value even after power control has been performed to bring a device associated with a worker of lowest priority to a status of a first stage of the power consumption level. Furthermore, in the following case, the device control unit 210 performs power control on the devices in order of decreasing priority, in which the device associated with the worker of high priority is first, so as to bring each of the devices to a status of a third stage of the power consumption level; the case is when it is predicted that total power consumption amount of the entire office over the predetermined period will exceed the target value or that a peak value of total power of the entire office will exceed the upper limit value even after power control has been performed to bring the device associated with the worker of lowest priority to a status of a second stage of the power consumption level.

Alternatively, the device control unit 210 may perform power control as follows. That is, the device control unit 210 performs power control on the device associated with the worker of high priority so as to bring the device to a status of the first stage of the power consumption level, a status of the second stage, and a status of the third stage in this order. Devices to be controlled by the device control unit 210 in this way are added one by one in order of decreasing priority of corresponding workers until it is predicted that total power consumption amount of the entire office over the predetermined period becomes equal to or lower than the target value or that a peak value of total power of the entire office becomes equal to or lower than the upper limit value.

The control priority level, the power consumption level, and the like associated with a position and a motion state of a worker in the control table for use in the power conservation control can be set arbitrarily depending on task and business category in the office, which is the control target area.

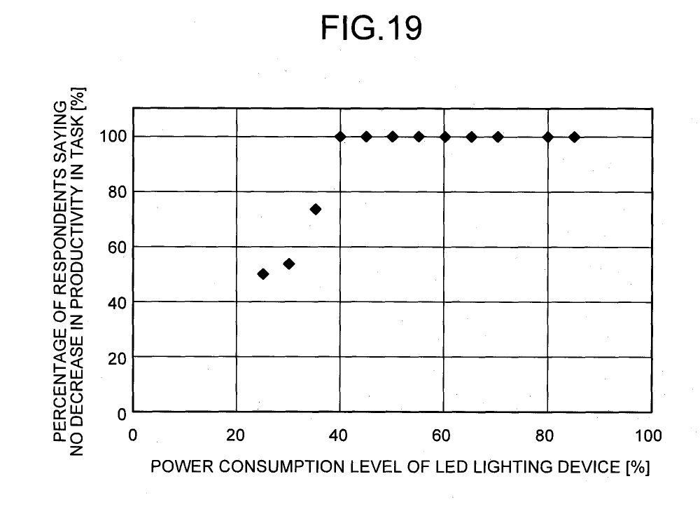

The control table illustrated in FIG. 17 is an example of the control table for use in the power conservation control. In the control table, values of the power consumption levels of “LIGHTING” associated with combinations of position and motion state are set based on a result of such survey as that illustrated in FIG. 19.

FIG. 19 is a diagram illustrating a result of survey on relationship between power consumption level of the LED lighting device 500 and decrease in worker's subjective productivity. A method employed for this survey includes artificially changing a light intensity status of the LED lighting device 500 in a typical office environment, and interviewing workers to ask whether or not productivity has decreased in each of the light intensity statuses. The workers are interviewed about each of a situation where the worker is performing a task using a PC and a situation where the worker is performing a task using a document. As a result, as illustrated in FIG. 19, all the workers say that there is no decrease in productivity when the light intensity status is 40 percent power consumption (i.e., reduction by 60 percent) or higher. On the basis of this result, the power consumption level of the LED lighting devices 500 associated with the sitting state is set to be higher than 40 percent irrespective of the state in the general office areas, the task support areas, and the executive area where it is highly possible that a task using a PC or a document is performed for a long period of time. On the other hand, the power consumption level of the LED lighting devices 500 is permitted to be set to be lower than 40 percent in the information management area, the life support area, and the traffic area where it is unlikely that a task using a PC or a document is performed.

As for the air conditioners 700, a report about magnitude of effect of reduction in power consumption of an air conditioner on work efficiency is provided (by Tawada, Ikaga, et al., “THE TOTAL EFFECT ON PERFORMANCE AND ENERGY CONSUMPTION CAUSED BY OFFICE'S THERMAL ENVIRONMENT”, February 2010, Journal of Environmental Engineering (Transactions of AIJ), Vol. 75, No. 648, pp. 213-219). Accordingly, the values of the power consumption level of “AIR CONDITIONER” in the control table illustrated in FIG. 17 are set to be no less than 80% even in the third stage of the power consumption level.

How to assort the conditions, which are combinations of position and motion state, in the control table for use in the power conservation control can also be set arbitrarily from various viewpoints. For instance, the motion state of a worker is divided into the three states, which are the sitting state, the standing state, and the walking state, in the control table illustrated in FIG. 17. A conversation state that is detectable using a microphone or the like means may be additionally included in the states. Additionally including the conversation state in the motion state in this manner can lead to optimum device control in a situation where communication is carried out face-to-face or using a telephone or the like.

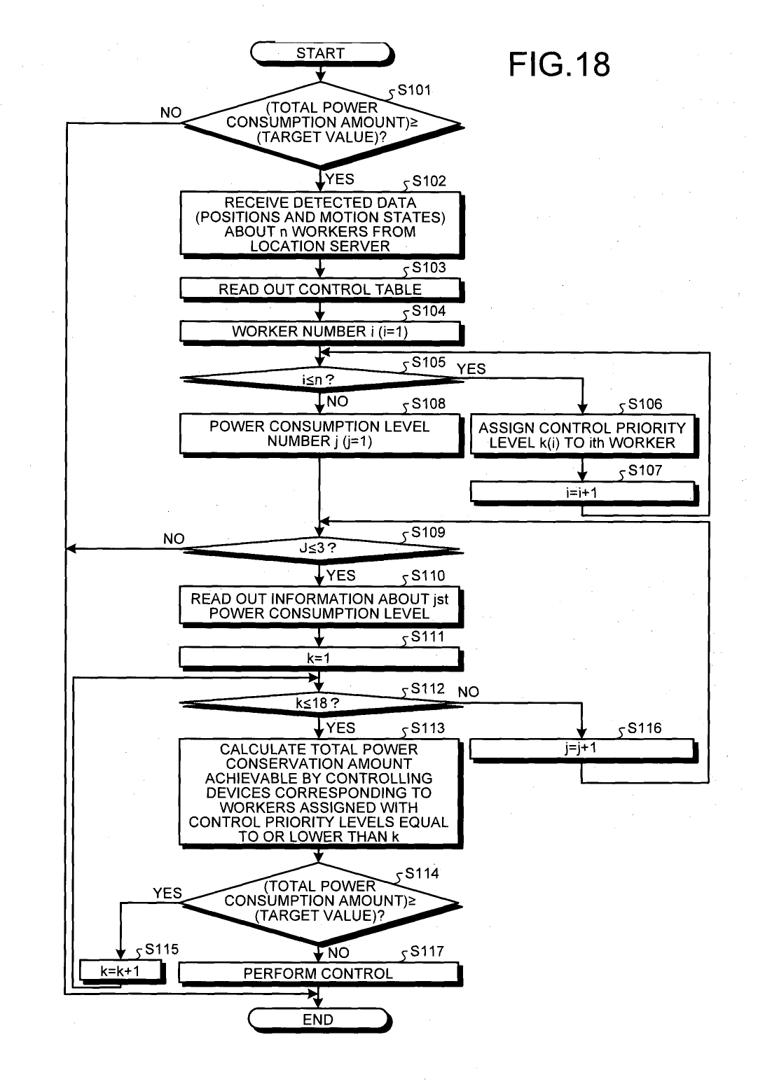

FIG. 18 is a flowchart illustrating a procedure for the power conservation control performed based on the control table illustrated in FIG. 17. The series of operations illustrated in the flowchart of FIG. 18 is repeatedly performed at fixed time intervals from starting time to quitting time of the office. Meanwhile, FIG. 18 illustrates a procedure for the power conservation control to be performed when the prediction unit 203 predicts that total power consumption amount of the entire office over the predetermined period will exceed the preset target value. The power conservation control is performed using a similar procedure also when the prediction unit 203 predicts that a peak value of total power of the entire office will exceed the predetermined upper limit value.

First, the prediction unit 203 determines whether or not total power consumption amount of the entire office over the predetermined period will exceed the target value (Step S101). When it is predicted that the total power consumption amount of the entire office over the predetermined period will exceed the target value (Yes in Step S101), the communication unit 201 receives detected data (positions and motion states) about all the workers (n workers) in the office from the location server 100 (Step S102). On the other hand, when it is predicted that the total power consumption amount of the entire office over the predetermined period will not exceed the target value (No in Step S101), the power conservation control ends.

Subsequently, the determining unit 204 reads out the control table stored in the storage unit 220 (Step S103). The determining unit 204 assigns priorities to all the workers in the office based on the detected data received from the location server 100 in Step S102 and the control table read out in Step S103. Each of the priorities corresponds to the control priority level that depends on a condition, which is a combination of position and motion state. More specifically, the determining unit 204 repeatedly performs operations including numbering the workers, about which the detected data is obtained, with i, which is the number from 1 to n, and assigning a control priority level k(i) to the ith worker while incrementing the value of i by one (Step S104 to Step S107).

When the control priority level k(i) is assigned to the nth worker (No in Step S105), the device control unit 210 designates a device, on which control is to be performed, and performs control on the device. The designation of the device and the control are performed to cause total power consumption amount of the entire office over the predetermined period to be equal to or lower than the target value using information about the control priority levels k assigned to the workers and the power consumption level, which is divided into the three stages. More specifically, the device control unit 210 numbers the three stages of the power consumption level with j, which is the number from 1 to 3. The device control unit 210 sets the number of j to 1 first to read out information about the first stage of the power consumption level stored in the storage unit 220 (Step S108 and Step S110). Subsequently, the device control unit 210 calculates an achievable total power conservation amount that can be achieved by controlling devices corresponding to workers assigned with control priority levels equal to or lower than k to the first stage of the power consumption level while incrementing the value of k, which is the control priority level assigned to each worker, by one from 1 to 18. The prediction unit 203 determines whether or not total power consumption amount remains exceeding the target value (Step Sill to Step S115).

When total power consumption amount remains not to become equal to or lower than the target value even though the value of k exceeds 18 (Yes in Step S114 and No in Step S112), the device control unit 210 increments the value of j to read out information about the second stage of the power consumption level stored in the storage unit 220 (Step S116 and Step S110). The device control unit 210 repeats similar operations to those described above using information about the second stage of the power consumption level while incrementing the value of k by one from 1 to 18 (Step S111 to Step S115).

When total power consumption amount remains not to become equal to or lower than the target value even though the value of k exceeds 18 after the power consumption level is switched to the second stage (Yes in Step S114 and No in Step S112), the device control unit 210 increments the value of j to read out information about the third stage of the power consumption level stored in the storage unit 220 (Step S116 and Step S110). The device control unit 210 repeats similar operations to those described above using information about the third stage of the power consumption level while incrementing the value of k by one from 1 to 18 (Step Sill to Step S115).

When it is determined that total power consumption amount will become equal to or lower than target value during the process described above, the device control unit 210 designates devices corresponding to workers assigned with control priority levels equal to or lower than k at this point in time as devices to be controlled, and performs control so as to bring each of the designated devices to a status of the jth stage of the power consumption level (Step S117). When total power consumption amount remains not to become equal to or lower than the target value even though the value of j exceeds 3 (No in Step S109), the power conservation control ends.

In the device control system of the embodiment, the control server 200 performs the power conservation control described above in the following cases. The cases include a case where it is predicted that total power consumption amount of an entire office, which is the control target area, over a predetermined period (e.g., a period from starting time to quitting time of the office) will exceed a preset target value and a case where it is predicted that a peak value of total power of the entire office, which is the control target area, will exceed a preset upper limit value. As a result, the device control system can achieve further power conservation while maintaining comfort of workers performing tasks to thereby reduce a decrease in productivity in the tasks.

In the embodiment described above, the power conservation control is performed in the case where, but not limited thereto, it is predicted that the total power consumption amount over the predetermined period will exceed the target value and the case where it is predicted that the peak value of total power will exceed the upper limit value. Alternatively, the power conservation control may be performed at appropriate timing associated with basic operations of the device control system.

In the embodiment described above, the determining unit 204 of the control server 200 assigns priorities to the workers based on, but not limited thereto, the combinations of position and motion state of the workers during the power conservation control. Alternatively, for example, priorities may be assigned based only on the positions of the workers or only on the motion states of the workers.

Assigning the priorities based only on the motion states of the workers may be performed in such a manner that, for instance, a worker of which motion state is the standing state or the walking state is assigned with higher priority than a worker of which motion state is the sitting state. The reason for this is because there is a high possibility that the worker of which motion state is the sitting state is performing a task, productivity in the task can decrease if control is performed to reduce power consumption of a device associated with this worker by priority. As for a worker of which motion state is the standing state and a worker of which motion state is the walking state, the worker of which motion state is the walking state is preferably assigned with higher priority than the worker of which motion state is the standing state. The reason for this is because the worker of which motion state is the walking state is not staying at one location, comfort of this worker is not impaired much even when power consumption of a device associated with the worker is reduced by priority.

Each of the location server 100 and the control server 200 according to the embodiment has the hardware configuration implemented in a typical computer and includes a control device such as a CPU, a storage device such as a ROM and a RAM, an external storage such as an HDD and/or a CD drive, a display device, and an input device such as a keyboard and/or a mouse.

Detection program to be executed by the location server 100 of the embodiment and control program to be executed by the control server 200 of the embodiment are each provided as a computer program product stored in a non-transitory tangible computer-readable storage medium as a file in an installable format or an executable format. The computer-readable storage medium can be, for instance, a CD-ROM, a flexible disk (FD), a CD-R, or a digital versatile disk (DVD).

Each of the detection program to be executed by the location server 100 of the embodiment and the control program to be executed by the control server 200 of the embodiment may be configured to be stored in a computer connected to a network, such as the Internet, and provided by downloading over the network. Each of the detection program to be executed by the location server 100 of the embodiment and the control program to be executed by the control server 200 of the embodiment may be configured to be provided or distributed via a network, such as the Internet.

Each of the detection program to be executed by the location server 100 of the embodiment and the control program to be executed by the control server 200 of the embodiment may be configured to be provided as being installed on a ROM or the like in advance.

The detection program to be executed by the location server 100 of the embodiment has a module structure including the units (the communication unit 101, the position determining unit 102, the motion-state detecting unit 103, and the correcting unit 104) described above. From viewpoint of actual hardware, the CPU (processor) reads out the detection program from the storage medium and executes the program to load the units on a main memory device, thereby generating the communication unit 101, the position determining unit 102, the motion-state detecting unit 103, and the correcting unit 104 on the main memory device.

The control program to be executed by the control server 200 of the embodiment has a module structure including the units (the communication unit 201, the power-consumption managing unit 202, the device control unit 210 (the lighting-device control unit 211, the electrical-outlet control unit 213, and the air-conditioner control unit 215), the prediction unit 203, and the determining unit 204) described above. From viewpoint of actual hardware, the CPU (processor) reads out the control program from the storage medium and executes the program to load the units on a main memory device, thereby generating the communication unit 201, the power-consumption managing unit 202, the device control unit 210 (the lighting-device control unit 211, the electrical-outlet control unit 213, and the air-conditioner control unit 215), the prediction unit 203, and the determining unit 204 on the main memory device.

### Example 1

Positions of workers are detected continually in the office space, layout of which is illustrated in FIG. 17 to reduce electric power supplied to the LED lighting devices 500, the air conditioners 700, and electrical devices plugged into the electrical outlets 600 to as little as possible in areas where no worker is present. Moreover, the power conservation control is performed based on the control table illustrated in FIG. 17 in areas where any worker is present. As a result, a goal of large power conservation that is unachievable by manual control can be achieved without decreasing subjective task productivity.

### Example 2

The first embodiment implementation is implemented by causing workers to perform subjective device control. Examples of the subjective device control include: increasing light intensity of the LED lighting device 500 that is perceived as dark; decreasing light intensity of the LED lighting device 500 that is perceived as bright; increasing power of the air conditioner 700 that is perceived as weak; decreasing power of the air conditioner 700 that is perceived as strong; plugging an electrical device into the electrical outlet 600 when a worker finds it necessary to supply power to the device; and unplugging an electrical device from the electrical outlet 600 when a worker finds it unnecessary to supply power to the device. As a result, not only a goal of large power conservation that is substantially same as that of the first example implementation is achieved, but also subjective comfort in tasks can be further increased. The subjective device control by the workers is performed using remote control application software installed in the smartphone 300 carried by each of the workers.

### Example 3

Determination is made only about whether or not each of the workers is in the sitting state, and the power conservation control is performed without taking positions of the workers into consideration based on the control table illustrated in FIG. 17 on devices corresponding to a worker(s) that is not in the sitting state. As a result, goal of large power conservation can be achieved without decreasing subjective task productivity, although the power conservation is not so large as that of the first embodiment implementation.

### Example 4

Determination is made only about whether or not each of the workers is in the walking state, and the power conservation control is performed without taking positions of the workers into consideration based on the control table illustrated in FIG. 17 on devices corresponding to a worker(s) in the walking state. As a result, a goal of large power conservation can be achieved without decreasing subjective task productivity, although the power conservation is not so large as that of the first embodiment implementation.

An electric device control system based on the example implementations can be modified in various manners. It is expected that any one of such variations can provide a power conservation effect that is superior to that of the conventionally-disclosed power control techniques.

1. An electric device control system comprising:
a position locating apparatus that detects positions and motion states of people; and
a control apparatus that controls at least one electric device, the control apparatus being connected to the position locating apparatus,
the position locating apparatus comprising:
a first receiving unit configured to receive data detected by a sensor associated with the people, the data indicating the positions and the motion states of the people, from the sensor; and
a transmitting unit configured to transmit the detected data to the control apparatus,
the control apparatus comprising:
a second receiving unit configured to receive the detected data from the position locating apparatus; and
a device control unit configured to assign a predetermined priority to the people based on at least one of the position information and the motion state information of the people, and to control a device associated with the people in accordance with the priority assigned to the people.

2. The electric device control system set forth in claim 1, wherein
when a prediction that total power consumption amount of the at least one electric device during a predetermined period will exceed a target value can be made, the determining unit assigns the predetermined priority to the people and
when the prediction that the total power consumption amount of the at least one electric device during the predetermined period will exceed the target value can be made, the device control unit controls the device associated with the people in accordance with the priority such that the device associated with the people becomes a predetermined status based on at least one of the position information and the motion state information of the people.

3. The electric device control system set forth in claim 2, wherein
when a prediction that the total power consumption amount of the at least one electric device during a predetermined period exceeds the target value can be made, even if the controller controls the at least one device associated with the people to whom a first priority is assigned such that the device associated with the people becomes a predetermined status based on the at least one of the position information and the motion state information of the people, the controller controls the at least one device associated with the people to whom a second priority is assigned that is lower than the first priority such that the device associated with the people becomes a predetermined status based on the at least one of the position information and the motion state information of the people.

4. The electric device control system set forth in claim 3, wherein
when a prediction that the total power consumption amount of the at least one electric device during a predetermined period exceeds the target value can be made, even if the controller controls the at least one device associated with the people such that the device associated with the people becomes a predetermined first status based on the at least one of the position information and the motion state information of the people, the controller controls the at least one device associated with the people such that the device associated with the people becomes a second status in which the total power consumption amount of the at least one electric device during a predetermined period is smaller than the first status based on the at least one of the position information and the motion state information of the people.

5. The electric device control system set forth in claim 1, wherein
when a prediction that a peak value of the total power of the at least one electric device associated with the people exceeds an upper limit value can be made, the determining unit assigns the priority to the people,
when a prediction that a peak value of the total power of the at least one electric device associated with the people exceeds an upper limit value can be made, the controller controls the at least one electric device associated with the people in accordance with the priority such that the device associated with the people becomes a predetermined status based on the at least one of the position information and the motion state information of the people.

6. The electric device control system set forth in claim 5, wherein
when a prediction that a peak value of the total power of the at least one electric device exceeds the upper limit value can be made, even if the controller controls the at least one device associated with the people to whom a first priority is assigned such that the device associated with the people becomes a predetermined status based on the at least one of the position information and the motion state information of the people, the controller controls the at least one device associated with the people to whom a second priority is set that is lower than the first priority such that the device associated with the people becomes a predetermined status based on the at least one of the position information and the motion state information of the people.

7. The electric device control system set forth in claim 6, wherein
when a prediction that a peak value of the total power of the at least one electric device associated with the people exceeds the upper limit value can be made, even if the controller controls the at least one device associated with the people such that the device associated with the people becomes a first predetermined status based on the at least one of the position information and the motion state information of the people, the controller controls the at least one device associated with the people such that the device associated with the people becomes a predetermined second status in which the total power of the at least one electric device is smaller than the first status based on the at least one of the position information and the motion state information of the people.

8. The electric device control system set forth in claim 1, wherein
the motion state information obtained by the motion-state detecting unit include motion state in which the people within the control target area are at least sitting, standing and walking, and
the determining unit assigns a first priority to people who are standing or walking, and assigns a second priority to people who are sitting based on the motion status information obtained, the second priority being lower than the first priority.

9. The electric device control system set forth in claim 8, wherein
the first priority includes a third priority and a forth priority that is lower than the third priority but higher than the second priority,
the determining unit assigns the third priority to the people who are walking, and assigns the fourth priority to the people who are standing.

10. The electric device control system set forth in claim 1, wherein
the first receiving unit receives image data of the control target area captured with an image capturing apparatus, and
the position locating apparatus further comprises a correcting unit that corrects the position information and the motion state information of the people based on the image data.

11. The electric device control system set forth in claim 1, wherein
the device associated with the people includes at least a lighting device and an air conditioner equipped within in the control target area.

12. A controller connected to a position locating apparatus that detects positions and motion states of people and configured to control at least one electric device,
the position locating apparatus comprising:
a first receiving unit configured to receive data detected by a sensor associated with the people, the data indicating the positions and the motion states of the people, from the sensor; and
a transmitting unit configured to transmit the detected data to the control apparatus,
the control apparatus comprising:
a second receiving unit configured to receive the detected data from the position locating apparatus; and
a device control unit configured to assign a predetermined priority to the people based on at least one of the position information and the motion state information of the people, and to control a device associated with the people in accordance with the priority assigned to the people.

13. A computer readable medium including a computer program product, the computer program product comprising instructions which, when executed by a computer, causes the computer to perform operation of a controller connected to a position locating apparatus that detects positions and motion states of people and configured to control at least one electric device,
the position locating apparatus comprising:
a first receiving unit configured to receive data detected by a sensor associated with the people, the data indicating the positions and the motion states of the people, from the sensor; and
a transmitting unit configured to transmit the detected data to the control apparatus,
the control apparatus comprising:
a second receiving unit configured to receive the detected data from the position locating apparatus; and
a device control unit configured to assign a predetermined priority to the people based on at least one of the position information and the motion state information of the people, and to control a device associated with the people in accordance with the priority assigned to the people,
the operation comprising:
receiving data detected by the sensor associated with the people, the data indicating the positions and the motion states of the people, from the sensor;
transmitting the detected data to the control apparatus;
receiving the detected data from the position locating apparatus;
assigning the predetermined priority to the people based on at least one of the position information and the motion state information of the people; and
controlling the device associated with the people in accordance with the priority assigned to the people.
